(19) United States
(12) Patent Application Publication
(10) Pub. No.: US 2017/0013082 A1
(43) Pub. Date: Jan. 12, 2017

(54) COMMUNICATION CONTROL APPARATUS, COMMUNICATION CONTROL METHOD, AND STORAGE MEDIUM

(71) Applicant: NEC Corporation, Tokyo (JP)

(72) Inventor: Takashi TORII, Tokyo (JP)

(73) Assignee: NEC Corporation, Tokyo (JP)

(21) Appl. No.: 15/120,709

(22) PCT Filed: Feb. 12, 2015
(86) PCT No.: PCT/JP2015/000627

§ 371 Date: Aug. 22, 2016

(30) Foreign Application Priority Data
Mar. 3, 2014 (JP) 2014-040255

(51) Int. Cl. H04L 29/08; H04L 12/26

(52) U.S. Cl. CPC H04L 67/322; H04L 43/08; H04L 67/10

(57) ABSTRACT

Provided is a communication control apparatus including a communication quality examination unit and a discard rule generating unit. The communication quality examination is configured to examine communication quality information representing communication quality in a communication network system. The discard rule generating unit is configured to generate a discard rule used for discarding communication data in the communication network system on the basis of the communication quality information examined by the communication quality examination unit, system knowledge information including information relating to retransmission control with respect to communication data used for implementing a service to be provided in the communication network system, and operational policy information including a priority with respect to one or more of the services to be provided in the communication network system.

### TECHNICAL FIELD

The present invention relates to a technology, in a communication network system in which a plurality of sites connected by a communication network provide services in cooperation with each other, enable to stably keep the quality of services when communication quality of the communication network for connecting the sites deteriorates in the communication network system. More specifically, the present invention relates to a technology for selectively discarding communication data so as to stably keep the quality of services when communication quality of the communication network for connecting the plurality of sites deteriorates.

### BACKGROUND ART

A communication network system (hereinafter, also referred to as a “network system”), in which a plurality of information processing apparatuses or the like are communicatively connected to each other via a communication network such as the Internet (hereinafter, also referred to as a “network”), is widely accepted.

In the network system, a plurality of sites can provide various services in cooperation with each other, by transmitting and receiving various communication data between information processing apparatuses or the like distributedly arranged at a plurality of sites. In recent years, a cloud system is widely accepted, as a system capable of providing services across a plurality of sites.

In the cloud system, for example, various virtualized apparatuses (for example information processing apparatuses and communication apparatuses) are arranged in a virtual environment configured by use of information processing apparatuses or the like, and various services are provided by the various virtualized apparatuses.

As the technology used for a cloud system progresses, a case such as replacing an existing system with a cloud system occurs. For example, by virtualizing a communication service in a communication carrier, which to is configured by a dedicated hardware component or the like in the conventional art, the communication service may be implemented by using a cloud system.

When it is assumed that a service is provided across a plurality of sites, traffic of various communication data flows through a network connecting the sites, as compared with a network which is closed within one site. Therefore, it is not always guaranteed that an appropriate communication band or communication quality is allocated with respect to the service.

Regarding a network for connecting sites, it is possible to control the band or to guarantee the quality at a normal time, when a failure, congestion, or the like does not occur. On the other hand, when a disaster, a failure, or the like has occurred, communication quality of a network for connecting sites may deteriorate due to occurrence of unexpected traffic or the like. In this case, loss of many communication data (communication data loss) may occur in communication between sites.

A system for providing services as described above may execute a process for retransmitting lost communication data (hereinafter, also referred to as a “retransmission process”) when loss of communication data relating to a service occurs.

The retransmission process may be implemented, for example, in a protocol stack for example a transmission control protocol (TCP). Further, the retransmission process may be implemented, for example, in an application for realizing a service. In any of the cases, the retransmission process mainly causes two problems.

The first problem is that effective communication performance may be further degraded because communication data resulting from the retransmission process further consumes a communication band of a network for connecting sites. In this case, many communication bands may be consumed by communication data relating to the retransmission process, which are increasing acceleratingly. Specifically, in this case, communication data resulting from a retransmission process may seriously affect communication quality.

The second problem is that a retransmission process particularly in an application may increase the processing load of a central processing unit (CPU) or the like for executing the application. This problem is mainly caused by consumption of the computation performance of a CPU by a retransmission process itself, or the like.

As described above, a network system may be unstable when unexpected communication traffic occurs by a disaster, a failure, or the like, or when a high processing load due to a retransmission process occurs in a system for providing a specific service.

In this case, it is desirable to control the amount of communication data to be transmitted to a network for connecting sites in order to stably operate a network system, and to keep the quality of services. Specifically, there is a demand for a technology capable of reducing communication data by band control or the like with respect to a communication network for connecting sites.

As the technology relating to band control, for example, the following patent literatures are disclosed.

PTL 1 discloses a technology for suppressing communication with respect to a site (quality-deteriorated site) on a network in which communication quality deteriorates, by notifying information relating to the quality-deteriorated site to another site.

The technology disclosed in PTL 1 notifies information relating to deterioration of communication quality to another site that is not directly communicated with a quality-deteriorated site, when deterioration of communication quality is detected in the quality-deteriorated site, as a result of monitoring a communication packet. The site that receives the notification suppresses communication with respect to the quality-deteriorated site. The technology disclosed in PTL 1 is able to smoothly restore the quality-deteriorated site by suppressing communication with respect to the quality-deteriorated site.

PTL 2 discloses a technology for controlling congestion by adjusting a packet discard rate according to traffic characteristics in a communication network.

The technology disclosed in PTL 2 determines a packet discard rate in so that the average queue length of a transmitting/receiving buffer in a network gateway apparatus being kept in a predetermined range. In the technology disclosed in PTL 2, an adjusted value of the packet discard rate is calculated by a fuzzy inference, and parameters of the fuzzy inference are adjusted by a learning function of a neural network. Thus, the technology disclosed in PTL 2 is capable of adjusting a packet discard rate according to traffic characteristics.

### CITATION LIST

### Patent Literature

[PTL 1] Japanese Laid-open Patent Publication No. 2009-081737

[PTL 2] Japanese Laid-open Patent Publication No. 2003-249953

### SUMMARY OF INVENTION

### Technical Problem

As described above, there is a demand for a technology capable of appropriately controlling a flow rate of communication data in a network for connecting sites according to a condition in a network system for providing services across a plurality of sites.

The technology disclosed in PTL 1 may uniformly suppress all the communications with respect to a specific site (quality-deteriorated site), regardless importance or the like of communication to be suppressed. Further, PTL 1 merely discloses a technology for allowing each communication terminal that receives a notification relating to quality deterioration spontaneously to suppress communication with respect to a quality-deteriorated site. That is, even when the technology disclosed in PTL 1 is employed, communication, from a communication terminal that is not able to handle the notification, is not suppressed.

The technology disclosed in PTL 2 may discard all the communication packets by uniformly applying the packet discard rate, on the basis of a criterion to keep the average queue length within a predetermined range. Therefore, a packet of communication data with high priority, and communication data critical to a system may be discarded.

The present invention is made in view of the situations described above. Specifically, a main objective of the present invention is to provide a communication control apparatus and the like, which enable to control a flow rate of communication data so as to stably keep the quality of services when communication quality of a network for connecting a plurality of sites connected by a communication network deteriorates.

### Solution to Problem

To achieve the above object, a communication control apparatus according to one aspect of the present invention includes following configurations. That is, the communication control apparatus according to one aspect of the present invention includes a communication quality examination means which examines communication quality information representing communication quality in a communication network system; and a discard rule generating means which generates a discard rule used for discarding communication data in the communication network system on the basis of the communication quality information examined by the communication quality examination means, system knowledge information including information relating to retransmission control with respect to communication data used for implementing a service to be provided in the communication network system, and operational policy information including a priority with respect to one or more of the services to be provided in the communication network system.

A communication control method according to one aspect of the present invention includes following configurations. That is, the communication control method according to one aspect of the present invention includes examining communication quality information representing communication quality in a communication network system; and generating a discard rule used for discarding communication data in the communication network system on the basis of the examined communication quality information, system knowledge information including information relating to retransmission control with respect to communication data used for implementing a service to be provided in the communication network system, and operational policy information including a priority with respect to one or more of the services to be provided in the communication network system.

Further, the object is also achieved by a computer program for implementing a communication control apparatus having the aforementioned configuration and a communication control method associated with the communication control apparatus by a computer, and by a computer-readable storage medium in which the computer program is stored.

### Advantageous Effects of Invention

According to the present invention, it is possible to selectively discard communication data in a network for connecting sites. Therefore, according to the present invention, it is possible to reduce consumption of a communication band by communication data, and to reduce a processing load for use in processing communication data. Consequently, according to the present invention, it is possible to stably operate a network system, and to prevent deterioration of the quality of services.

### BRIEF DESCRIPTION OF DRAWINGS

FIG. 1 is a diagram exemplifying a configuration of a network system according to a first exemplary embodiment of the present invention;

FIG. 2 is a diagram conceptually illustrating an interface of a specific service to be provided in the network system according to the first exemplary embodiment of the present invention;

FIG. 3 is a diagram exemplifying a relationship between components constituting the network system according to the first exemplary embodiment of the present invention;

FIG. 4 is a block diagram exemplifying a functional configuration of an inter-site network control apparatus according to the first exemplary embodiment of the present invention;

FIG. 5 is a diagram illustrating a specific example of information relating to system knowledge according to the first exemplary embodiment of the present invention;

FIG. 6 is a diagram illustrating a specific example of information relating to an operational policy according to the first exemplary embodiment of the present invention;

FIG. 7 is a flowchart exemplifying a process for generating a discard rule of communication data, and a process for applying the discard rule in the first exemplary embodiment of the present invention;

FIG. 8 is a flowchart exemplifying a process for generating a discard rule of communication data in the inter-site network control apparatus according to the first exemplary embodiment of the present invention;

FIG. 9 is a diagram illustrating a first specific example of a discard list according to the first exemplary embodiment of the present invention;

FIG. 10 is a diagram illustrating a second specific example of a discard list according to the first exemplary embodiment of the present invention;

FIG. 11 is a diagram illustrating a third specific example of a discard list according to the first exemplary embodiment of the present invention;

FIG. 12 is a diagram exemplifying a process for updating a discard rule according to the first exemplary embodiment of the present invention;

FIG. 13 is a diagram illustrating a first specific example of a discard rule according to the first exemplary embodiment of the present invention;

FIG. 14 is a diagram illustrating a second specific example of a discard rule according to the first exemplary embodiment of the present invention;

FIG. 15 is a diagram illustrating a third specific example of a discard rule according to the first exemplary embodiment of the present invention;

FIG. 16 is a diagram illustrating a fourth specific example of a discard rule according to the first exemplary embodiment of the present invention;

FIG. 17 is a diagram illustrating a fifth specific example of a discard rule according to the first exemplary embodiment of the present invention;

FIG. 18 is a diagram illustrating a sixth specific example of a discard rule according to the first exemplary embodiment of the present invention;

FIG. 19 is a diagram exemplifying a relationship between components constituting the network system according to the first exemplary embodiment of the present invention;

FIG. 20 is a block diagram exemplifying a functional configuration of an inter-site network control apparatus according to a second exemplary embodiment of the present invention;

FIG. 21 is a block diagram exemplifying a functional configuration of an inter-site network control apparatus according to a third exemplary embodiment of the present invention; and

FIG. 22 is a block diagram exemplifying a hardware configuration of an information processing apparatus capable of implementing components constituting the network system according to each of the exemplary embodiments of the present invention.

### DESCRIPTION OF EMBODIMENTS

Next, exemplary embodiments for implementing the present invention are described referring to the drawings. The configurations described in the following exemplary embodiments are merely examples. The technical scope of the present invention is not limited by the configurations.

### First Exemplary Embodiment

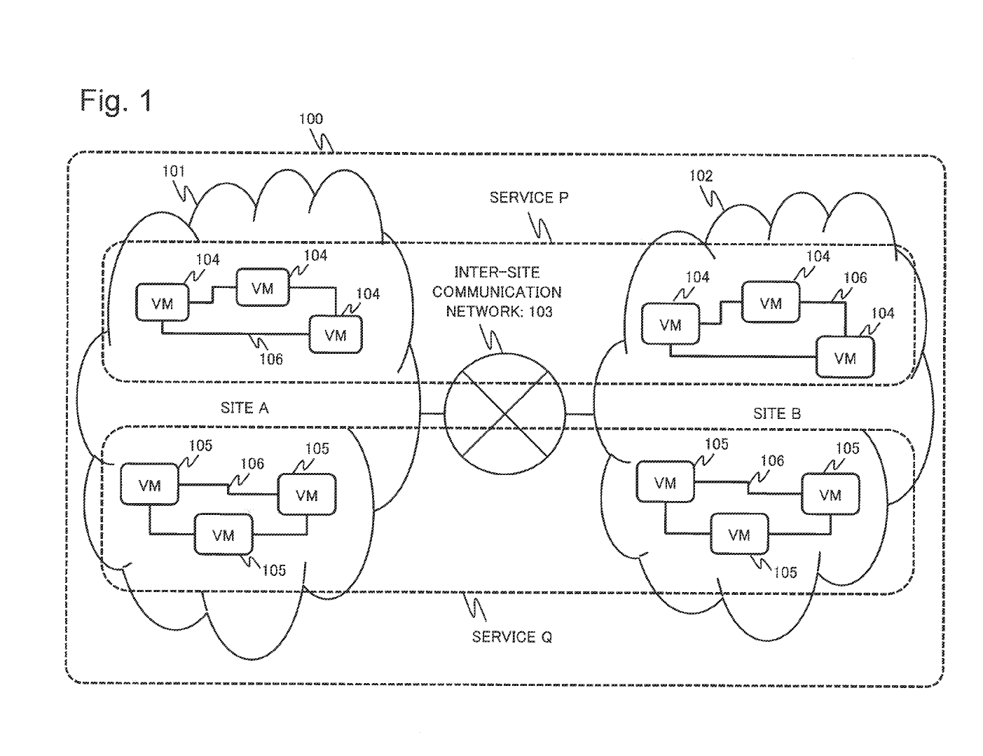

FIG. 1 is a diagram conceptually exemplifying a configuration of a network system 100 according to the exemplary embodiment.

As exemplified in FIG. 1, the network system 100 in the exemplary embodiment includes a plurality of sites (a site “A” (101) and a site “B” (102) in FIG. 1). These sites are communicatively connected to each other by any inter-site network 103.

At each of the sites, at least one or more virtual machines (VMs, indicated by 104 and 105 exemplified in FIG. 1) are disposed. These virtual machines (VMs 104 and VMs 105) are configured to provide a specific service (for example a service “P” and a service “Q” exemplified in FIG. 1) in cooperation with each other. These virtual machines may be virtual computers or virtual communication control apparatuses provided in a known virtual environment constituted by computers or the like. A known technology may adopted for the virtual environment, therefore, detailed description about the virtual environment is omitted herein.

Note that in the specific example exemplified in FIG. 1, the network system 100 is constituted by using virtual machines such as the VMs 104 and the VMs 105. The exemplary embodiment, however, is not limited to the above. The network system 100 in the exemplary embodiment may be constituted by using a physical information processing apparatus, in addition to the VMs.

In the exemplary embodiment, these virtual machines (VMs 104 and VMs 105) for providing the service “P” or the service “Q” are communicatively connected to each other. Specifically, these virtual machines are communicatively connected to each other by a known intra-site network 106 within the site “A” (101) or within the site “B” (102). Further, virtual machines arranged at different sites from each other are communicatively connected by the inter-site network 103.

Note that the intra-site network 106 and the inter-site network 103 may be configured by using any known communication network. For example, the intra-site network 106 may be configured by an in-house communication network such as a local area network (LAN). Further, for example, the inter-site network 103 may be configured by a wide area communication network such as the Internet.

Further, regarding each of the communication networks, any known communication protocol may be employed, as necessary. The communication protocol may be a TCP/IP (Internet Protocol), a UDP (User Datagram Protocol)/IP, or the like.

As the communication network, a packet communication network (for example an IP network) in which communication data is transmitted and received in terms of packets may be employed. In this case, communication data associated with various services is divided into packets, and the packets are transmitted and received in the inter-site network 103.

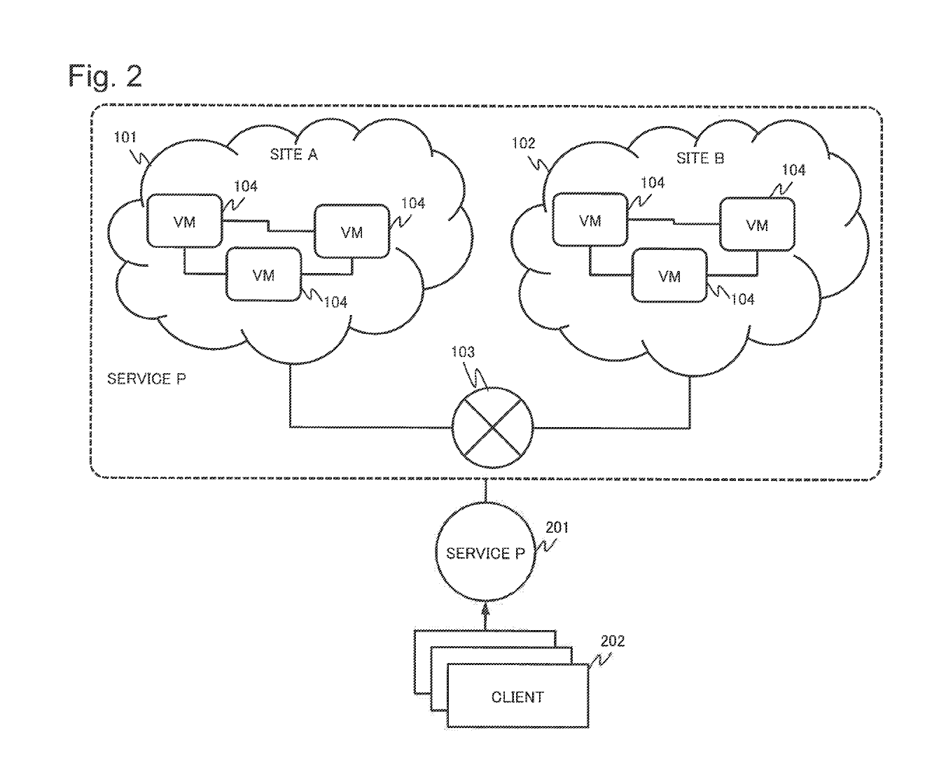

FIG. 2 is a diagram conceptually illustrating an interface for providing various services to be provided in the exemplary embodiment to a client. In FIG. 2, the service “P” is exemplified as a specific example. The same idea is also applied to the service “Q”.

As described above, various services in the exemplary embodiment are provided across the site “A” (101) and the site “B” (102). For example, when a client 202 uses a specific service (for example the service “P”), the client 202 may use an interface 201 being provided as an interface of the service “P”. In this case, the client 202 does not have to recognize how the service “P” to be provided by the interface 201 is specifically implemented. The client 202 is capable of using the service “P” without being aware of a physical layout about the site “A” (101) and the site “B” (102), or that a service is provided across the site “A” (101) and the site “B” (102).

As will be described later, various services to be provided in the network system in the exemplary embodiment are constituted by a set of message sequences to be transmitted and received between a plurality of sites. The message sequence includes one or more messages. The message may include various commands associated with the service.

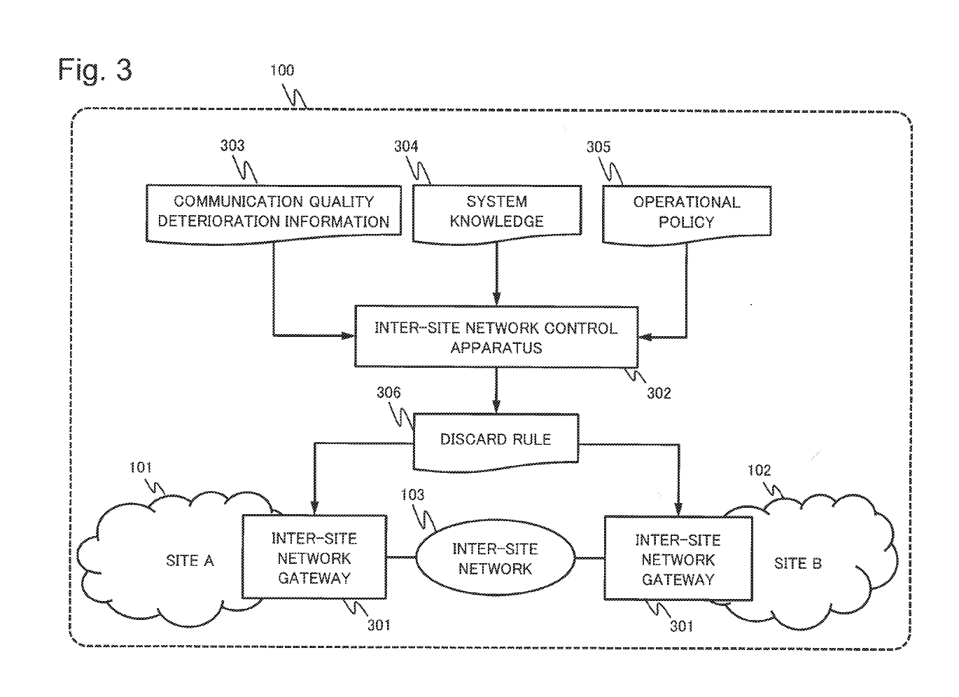

Next, components for implementing a process for selectively discarding communication data in the network system 100 in the exemplary embodiment are described referring to FIG. 3.

The network system 100 in the exemplary embodiment includes inter-site network gateways 301, and an inter-site network control apparatus 302. In the exemplary embodiment, these components are communicatively connected to each other. In the exemplary embodiment, as will be described later, selectively discarding communication data is implemented by cooperation of the inter-site network gateways 301, and the inter-site network control apparatus 302.

In the following, details of each of the components is described.

The inter-site network gateway 301 is a communication control apparatus for controlling transmitting and receiving of various communication data between each of the sites (for example the site “A” (101) and the site “B” (102) exemplified in FIG. 3), and the inter-site network 103.

For example, the inter-site network gateway 301 in the exemplary embodiment is capable of controlling transmitting and receiving of communication data relating to a specific service such as the service “P” or the service “Q”. Specifically, the inter-site network gateway 301 in the exemplary embodiment is capable of controlling a communication band usable by communication data relating to the specific service for each service.

The inter-site network gateway 301 is not limited to the above. The inter-site network gateway 301 may control a communication band available for communication data relating to each “flow”, which is a unit for controlling communication traffic, for example, in the OpenFlow (registered trademark) network.

In the following, it is assumed that the inter-site network gateways 301, and the inter-site network control apparatus 302 to be described later are capable of controlling a communication band at least for each service or for each flow. Note that in the following, an example is described, in which a communication band is controlled for each service.

In the exemplary embodiment, a method for selectively discarding communication data is employed as the aforementioned band control method. The inter-site network gateway 301 in the exemplary embodiment selectively discards at least a part of communication data relating to a specific service on the basis of a discard rule described later (an element indicated by the numeral 306 exemplified in FIG. 3). In this case, the inter-site network gateway 301 may specify the service to which communication data is associated by analyzing each communication data, for example. Note that a known technology may be appropriately employed as a specific method for analyzing communication data.

The inter-site network gateway 301 in the exemplary embodiment may be configured (implemented) by a communication control apparatus as a hardware component. Further, the inter-site network gateway 301 may be configured (implemented) by combination of an information processing apparatus such as a computer, and a software program to be executed by the information processing apparatus. Further, the inter-site network gateway 301 may be a virtual communication control apparatus configured in a virtual environment. A specific operation of the inter-site network gateway 301 is described later.

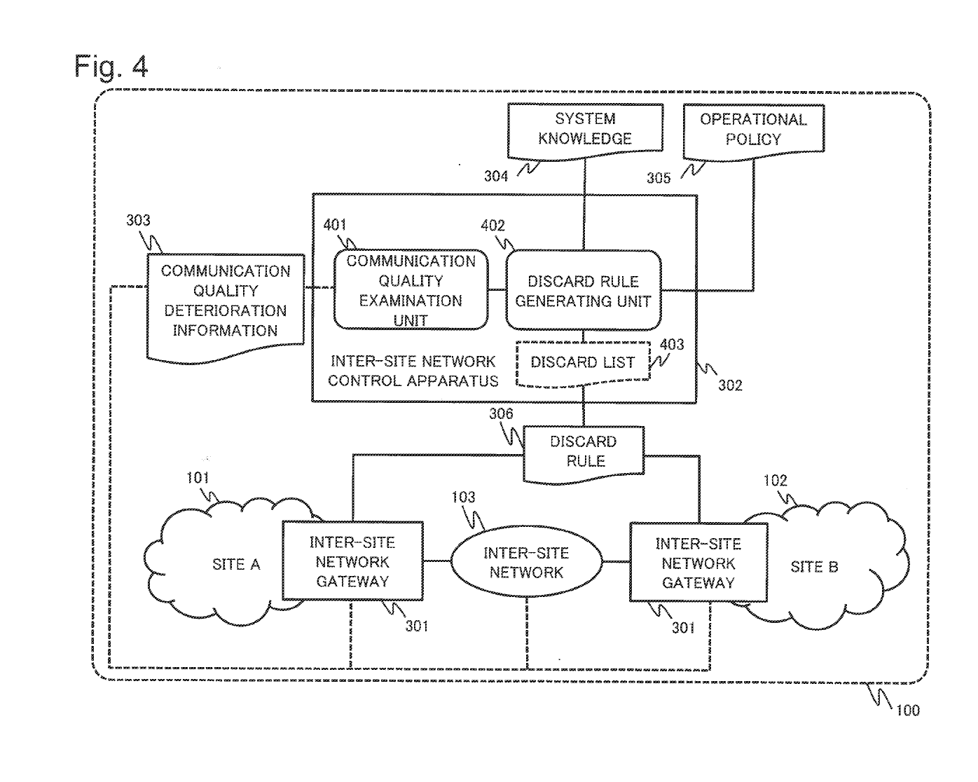

Next, the inter-site network control apparatus 302 as a communication control apparatus is described referring to FIG. 4 to FIG. 6.

The inter-site network control apparatus 302 generates a discard rule 306 to be used, by the inter-site network gateway 301, for determining communication data to be discarded. Then, the inter-site network control apparatus 302 applies the discard rule 306 to the inter-site network gateway 301.

FIG. 4 is a block diagram exemplifying a functional configuration of the inter-site network control apparatus 301 according to the exemplary embodiment. As exemplified in FIG. 4, the inter-site network control apparatus 301 according to the exemplary embodiment includes a communication quality examination unit 401 and a discard rule generating unit 402.

The communication quality examination unit 401 monitors the inter-site network 103, and collects information relating to deterioration of communication quality (indicated by 303 in FIG. 3, hereinafter, referred to as “communication quality deterioration information”). Note that the communication quality examination unit 401 may monitor intra-site networks (for example indicated by 106 in FIG. 1) in addition to the above, and may additionally collect information relating to deterioration of communication quality in the intra-site networks 106.

The communication quality deterioration information 303 includes, for example, statistical information relating to various communication data to be transmitted and received in the inter-site network 103. The statistical information may include, for example, an average communication speed, a communication amount per fixed time, a rate of change in communication amount, and a loss rate of communication data. The communication quality deterioration information 303 in the exemplary embodiment includes at least information relating to loss of communication data (hereinafter, also referred to as “communication data loss”) generated by an increase of traffic.

When the communication data loss occurs, a system for providing various services may execute a retransmission process of communication data relating to the service. A communication band of the inter-site network 103 is further consumed by the retransmission process. As a result, communication data loss may be increased.

The communication quality deterioration information 303 includes information relating to the communication data loss. Therefore, the communication quality examination unit 401 in the exemplary embodiment is able to detect a degree of deterioration of communication quality of the inter-site network 103 on the basis of the communication quality deterioration information 303.

The communication quality examination unit 401 may directly monitor the inter-site network 103. The communication quality examination unit 401 may also examine information relating to loss of communication data collected in the inter-site network gateway 301 or in another communication control apparatus.

The discard rule generating unit 402 in the exemplary embodiment generates the discard rule 306 on the basis of system knowledge 304 and an operational policy 305. Then, the discard rule generating unit 402 applies the discard rule 306 to the inter-site network gateways 301 as described above. In the exemplary embodiment, the discard rule generating unit 402 generates the discard rule 306 on the basis of a notification from the communication quality examination unit 401.

The system knowledge 304 includes information relating to a system for providing various services in the network system 100. Specifically, the system knowledge 304 in the exemplary embodiment includes information relating to a retransmission process of communication data relating to a specific service in a system for providing the specific service.

In the exemplary embodiment, a provider of each service, an operator of a system for providing each service, or the like (hereinafter, also referred to as a “service provider or the like”) may register in advance the system knowledge 304 in any information processing apparatus or the like, which is referable from the inter-site network control apparatus 302. And, the discard rule generating unit 402 may be configured to obtain the system knowledge 304. Further, the service provider or the like may register in advance the system knowledge 304 in the inter-site network control apparatus 302.

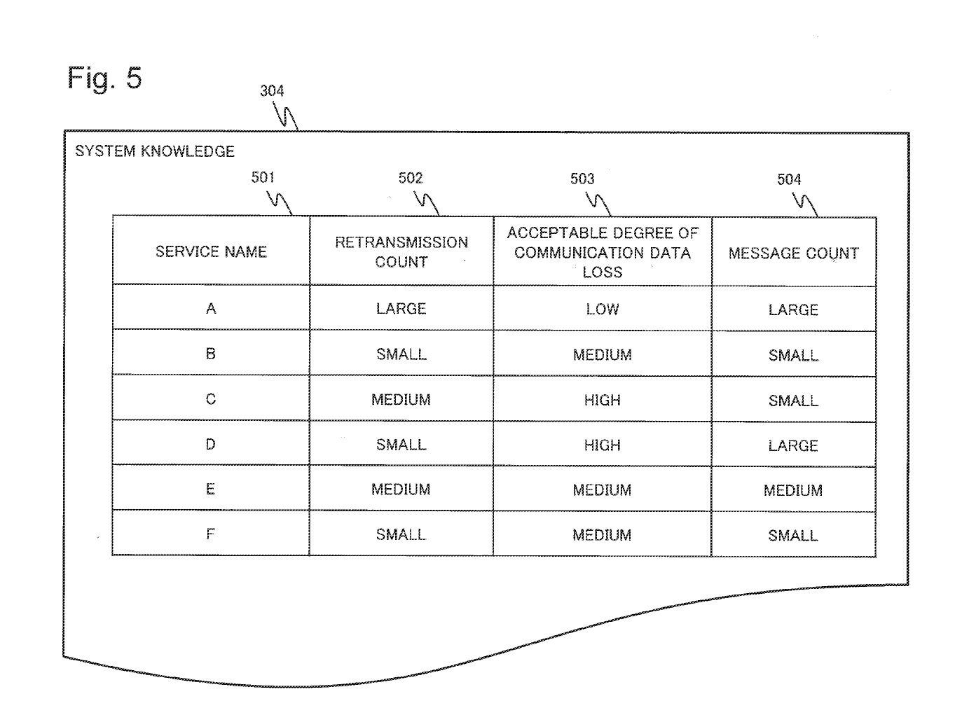

In the following, the system knowledge 304 is described referring to a specific example exemplified in FIG. 5.

In the specific example exemplified in FIG. 5, the system knowledge 304 includes information relating to a retransmission count 502, a acceptable degree of communication data loss 503, and a message count 504, in association with a service to be identified by a specific service name (indicated by 501 in FIG. 5). Note that the system knowledge 304 may include information other than the above.

The retransmission count 502 is information representing a frequency of retransmission process (amount of the number of times of retransmission process) when communication data relating to a specific service is lost in the inter-site network 103 or in the intra-site network 106. In the specific example exemplified in FIG. 5, information representing a degree such as “large”, “medium”, or “small” is registered with regard to the retransmission count 502. The retransmission count 502 is not limited to the above. A numerical value representing the number of retransmission may be registered in the retransmission count 502.

In this example, a retransmission process executed in a system providing various services is briefly described.

In the exemplary embodiment, a system for providing each service is configured to retransmit communication data, when the system does not receive any reply after a predetermined period of time has elapsed from the time of transmission of the communication data, so as to securely perform communication via a network. Specific configuration of retransmission process differs depending on each service or a system for providing the service. Further, the configuration on retransmission may be modified on the basis of setting with respect to the service.

For example, when a communication protocol (for example, TCP) configured to implement a retransmission process is adopted in a specific service, an upper layer application or the like which uses the communication protocol, does not have to execute a retransmission process by the application itself. On the other hand, when a communication protocol (for example, UDP) which is not configured to implement a retransmission process is adopted in a specific service, an upper layer application which uses the communication protocol may implement a retransmission process. The retransmission count 502 in the exemplary embodiment may include information relating to a timing at which such a retransmission process is executed or the number of retransmission.

When a system for providing the specific service does not receive a reply even when a retransmission process relating to the specific service is executed by a predetermined number of times, the system executes an error process. Also when the system for providing the service does not receive a reply even after a predetermined period of time elapses after a retransmission process relating to the service is executed, the system executes an error process. Note that in the following, a case in which a reply to a retransmission process is not received is also referred to as a “retransmission timeout”.

The system knowledge 304 in the exemplary embodiment may include information relating to, for example, a time interval (retransmission interval) at which a system for providing a specific service executes a retransmission process, in addition to the retransmission count 502. The retransmission interval may differ depending on a service or a communication protocol to be employed by the service. For example, the retransmission interval may be a fixed interval. The retransmission interval may be short at the beginning, and may be gradually extended.

When the system for providing the specific service executes the retransmission process, communication data with regard to the process consumes a network band, and the retransmission process itself consumes the processing performance of the system. Specifically, the retransmission process consumes various resources in the network system 100. In view of the above, it is desirable that the amount of resources which is allocated for the retransmission process can be appropriately selected, as necessary, according to the content of service for which the retransmission process is executed.

In view of the above, in the exemplary embodiment, the retransmission count 502 relating to each service is included in the system knowledge 304, and the inter-site network control apparatus 302 generates the discard rule 306 on the basis of the system knowledge 304. According to this configuration, the inter-site network control apparatus 302 is capable of adjusting the resources to be consumed by a retransmission process.

The acceptable degree of communication data loss 503 includes information representing a degree (degree of acceptance) of acceptable communication data loss according to an influence on a system for providing a specific service when the communication data loss occurs.

In the specific example exemplified in FIG. 5, information representing a degree of influence such as “high”, “medium”, or “low” is registered as the information. A specific format of information to be registered as the communication data loss acceptance degree 503 may be selected appropriately. For example, a numerical value representing a magnitude of influence may be registered with respect to the communication data loss acceptance degree 503.

In the exemplary embodiment, when an influence on a service is significant when communication data loss occurs, a low degree of acceptance is set in the communication data loss acceptance degree 503 (e.g. “service A” exemplified in FIG. 5). In this case, occurrence of communication data loss indicates that some kind of anomalous situations have occurred in a system for providing the service.

On the other hand, when a service can be continuously provided by the retransmission process even after communication data loss occurs, a high degree of acceptance is set to the communication data loss acceptance degree 503 (e.g. “service C” exemplified in FIG. 5). Regarding a service of which a high degree of acceptance is set to the communication data loss acceptance degree 503, it does not always indicate that anomalous situations have occurred in the system, even after communication data loss has occurred.

A degree of acceptance to be set in the communication data loss acceptance degree 503 with respect to each service 501 is appropriately provided (or selected) by a service provider or the like of each service according to the characteristic or the like of each service.

The message count 504 includes information representing the length of a message sequence constituting a specific service to be identified by the service name 501. More specifically, the message count 504 may represent the number of messages to be included in the message sequence constituting the specific service. In this case, the larger the message count is, the longer the message sequence is.

In the specific example exemplified in FIG. 5, information representing a degree such as “large”, “medium”, or “small” is registered in the message count 504. A specific numerical value representing, for example, the number of messages to be included in a message sequence may be registered in the message count 504. Further, when a plurality of message sequences are used with regard to the service 501, an average value of the message numbers or a maximum value of the message numbers may be registered with respect to the message count 504.

As exemplified in FIG. 5, when there exist “service A” of which message sequence is long (the message count is large), and “service B” of which message sequence is short (the message count is small), it is assumed that communication data loss occurs in each of the services. When a retransmission timeout occurs with a same probability in the systems for providing each service, “service A” of which message sequence is long, may be more significantly affected. This is because when a retransmission timeout occurs in a middle of the long message sequence, the system for providing the service may discard the entirety of the message sequence, and execute the process again. Further, in general, when a message sequence is long, there are many factors leading to an error.

As described above, the length of a message sequence with respect to each service affects the consumption amount of various resources when a retransmission process is executed. In view of the above, in the exemplary embodiment, the message count 504 with respect to each service is included in the system knowledge 304, and the inter-site network control apparatus 302 generates the discard rule 306 on the basis of the system knowledge 304. According to this configuration, the inter-site network control apparatus 302 is capable of adjusting resources to be consumed by a retransmission process.

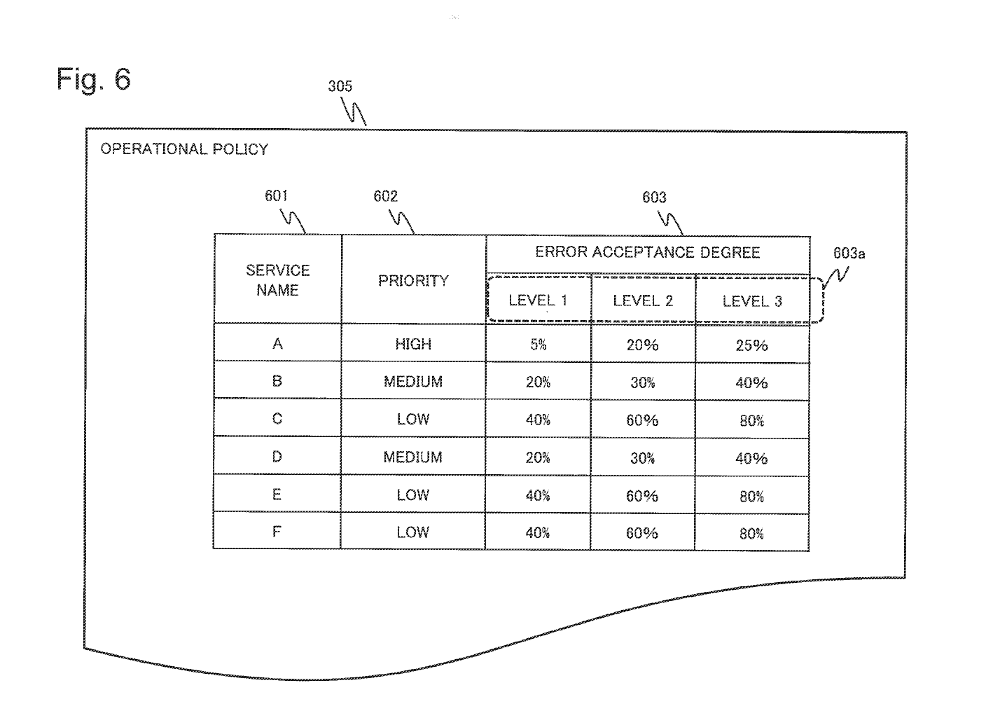

Next, the operational policy 305 is described referring to a specific example exemplified in FIG. 6.

The operational policy 305 includes information representing a priority (degree of importance) with respect to each service to be provided in the network system 100. More specifically, as exemplified in FIG. 6, the operational policy 305 includes information relating to a priority 602 and an error acceptance degree 603 with respect to a service identified by a specific service name (indicated by 601 in FIG. 6).

The priority 602 is information representing a priority set for a service specified by the service name 601. In the exemplary embodiment, information representing a degree such as “high”, “medium”, or “low” is registered in the priority 602. For example, a specific numerical value representing a priority may be registered in the priority 602.

In the exemplary embodiment, for example, a service provider or the like of each service sets the priority 602, by taking into consideration an influence on a service when communication data loss relating to each service occurs.

More specifically, a service provider or the like sets the priority 602 with respect to each service, taking into consideration, for example, the following items (i) to (iii).

(i) an influence on a system which provides a specific service, when communication data loss occurs in the specific service

(ii) an influence on a message sequence constituting a specific service when communication data loss occurs in the specific service

(iii) an influence on a processing load in a system which provides a specific service, when communication data loss occurs in the specific service

The item (i) is related to the acceptable degree of communication data loss 503 in the system knowledge 304. A service provider or the like may, for example, consider a degree of acceptable communication data loss with respect to a system when setting the priority 602. Specifically, when, with regard to a specific service, a degree of acceptable communication data loss is low, a high priority may be set with respect to the service.

The item (ii) is related to the message count 504 in the system knowledge 304. For example, a service provider or the like may set a high priority with respect to a service of which message sequence is long.

The item (iii) is related to a processing load of a retransmission process when communication data loss occurs in a specific service. For example, a service provider or the like may set a high priority with respect to a service of which processing load is high when a retransmission process is executed.

The error acceptance degree 603 includes information representing an acceptable degree of an error being caused by communication data loss or the like, in a specific service. That is, the error acceptance degree 603 is information representing acceptable degree of occurrence of error in a situation where the occurrence of the error is unavoidable in a specific service.

As exemplified in FIG. 6, a plurality of levels 603a (level 1 to level 3 in FIG. 6) are set in the error acceptance degree 603 in the exemplary embodiment. Then, information representing an acceptable range in which an error is acceptable is set with respect to each of the levels.

In the specific example exemplified in FIG. 6, an acceptance rate of error (hereinafter, also referred to as an “error acceptance rate”) is set as the information representing an error acceptable range. The error acceptance rate is information representing an acceptable ratio of occurrence of error in a specific service. Note that in the exemplary embodiment, the error acceptance rate for each level may be set in such a manner that the error acceptance degree increases according to a level. Specifically, the error acceptance rate may be set in such a manner that as the level is raised, the error acceptable range becomes wider.

The error acceptance rate may be used as information representing an acceptable ratio of error which is occurred in a specific service, when communication data relating to the specific service is discarded. In the specific example exemplified in FIG. 6, for example, regarding “service A”, when the error acceptance degree is “level 1”, it is possible to accept an error up to the range “5%”.

In the exemplary embodiment, each service provider or the like may register in advance the aforementioned operational policy 305 in an any information processing apparatus or the like, which is referable from the inter-site network control apparatus 302. Then, the discard rule generating unit 402 may be configured to obtain the operational policy 305. A service provider or the like may register in advance the operational policy 305 in the inter-site network control apparatus 302.

In the following, generation of the operational policy 305 by each service provider or the like is described using a specific example.

For example, when a mobile communication service such as a long term evolution (LTE) is provided, an evolved packet core (EPC) is a basic service for controlling a bearer for a mobile terminal to be connected to each service.

In an LTE, various services such as voice over IP (VoIP), IP multimedia subsystem (IMS), e-mail transmitting/receiving, video transmission, and Internet connection are implemented with use of a core network service provided by an EPC.

Therefore, when a communication failure occurs in the EPC, all the other services are affected by the communication failure. On the other hand, when a failure occurs in each service, although the EPC is capable of executing communication, the service is not provided to an end user.

That is, a service provider or the like is required to appropriately judge which service is to be prioritized in a network system, by taking the convenience of an end user, a condition, and the like, into consideration. A service provider or the like prepares the operational policy 305 on the basis of the judgment result.

The discard rule generating unit 402 in the exemplary embodiment generates the discard rule 306 on the basis of the operational policy 305 prepared as described above. Therefore, as will be described later, the network system 100 in the exemplary embodiment is capable of continuously providing a service of which priority is high. Further, the network system 100 in the exemplary embodiment is capable of maintaining stability of the entire network system by discarding communication data in a service of which priority is low.

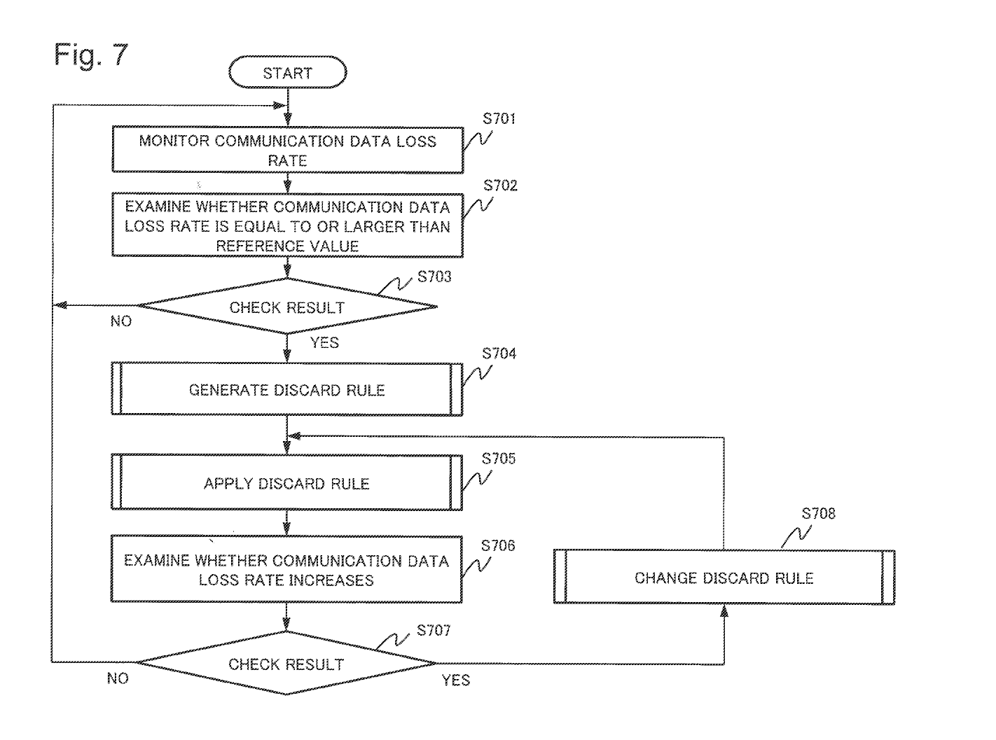

Next, an operation of the inter-site network control apparatus 302, and an operation of the inter-site network gateway 301 in the exemplary embodiment configured as described above are described referring to the flowchart exemplified in FIG. 7.

Firstly, the communication quality examination unit 401 in the inter-site network control apparatus 302 examines the communication quality deterioration information 303 in the inter-site network 103. More specifically, the communication quality examination unit 401 collects information relating to communication data loss generated in the inter-site network 103. The communication quality examination unit 401 in the exemplary embodiment collects a probability of occurrence of communication data loss (hereinafter, also referred to as a “communication data loss rate”), as the information relating to communication data loss (Step S701).

Next, the communication quality examination unit 401 examines whether the communication data loss rate collected in Step S701 is equal to or larger than a predetermined reference value (Step S702). In this case, the communication quality examination unit 401 may notify the discard rule generating unit 402 of the examination result, and information relating to a communication data loss rate. The reference value is a value (such as a probability value representing the communication data loss rate) by which the communication quality examination unit 401 is able to determine whether communication quality is deteriorated in the inter-site network 103. The reference value may be appropriately determined by a service provider or the like.

When a communication data loss rate is equal to or larger than the predetermined reference value, as a result of examination in Step S702 (YES in Step S703), the discard rule generating unit 402 generates a discard rule (Step S704).

More specifically, when the discard rule generating unit 402 detects that communication data loss occurs with a probability equal to or larger than the predetermined reference value in the inter-site network 103, the discard rule generating unit 402 determines that communication quality is deteriorated in the inter-site network 103. In this case, the discard rule generating unit 402 generates the discard rule (306 in FIG. 3) usable for selectively discarding communication data in order to stably operate the network system 100.

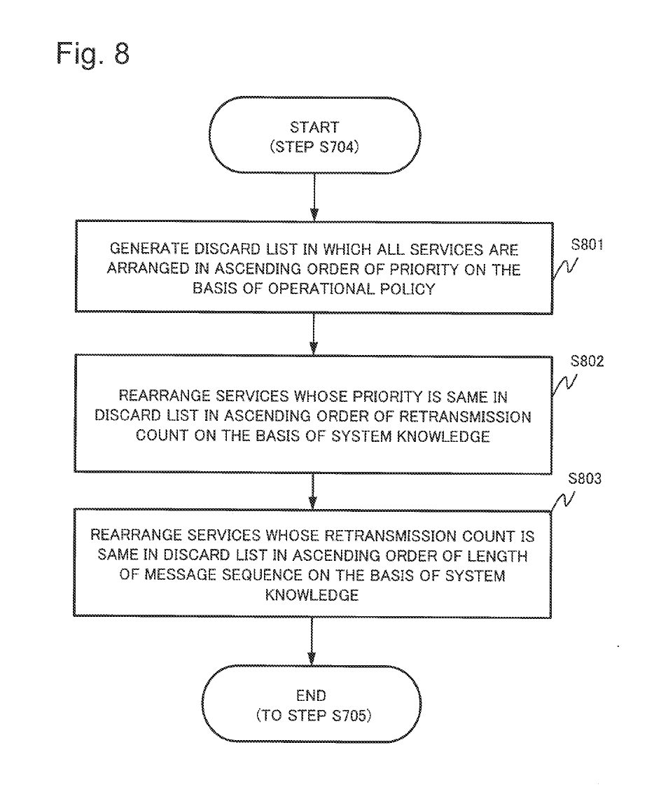

In the following, generation of the discard rule 306 is described referring to the flowchart exemplified in FIG. 8.

The discard rule generating unit 402 in the exemplary embodiment generates the discard rule 306 on the basis of the above-described system knowledge 304, the operational policy 305, and the communication quality deterioration information 303 (in this case, a communication data loss rate). The communication data loss rate is notified via the communication quality examination unit 401.

Firstly, the discard rule generating unit 402 generates a discard list in which all the services described in the operational policy 305 are arranged in the ascending order of the priority registered in the priority 602 (Step S801).

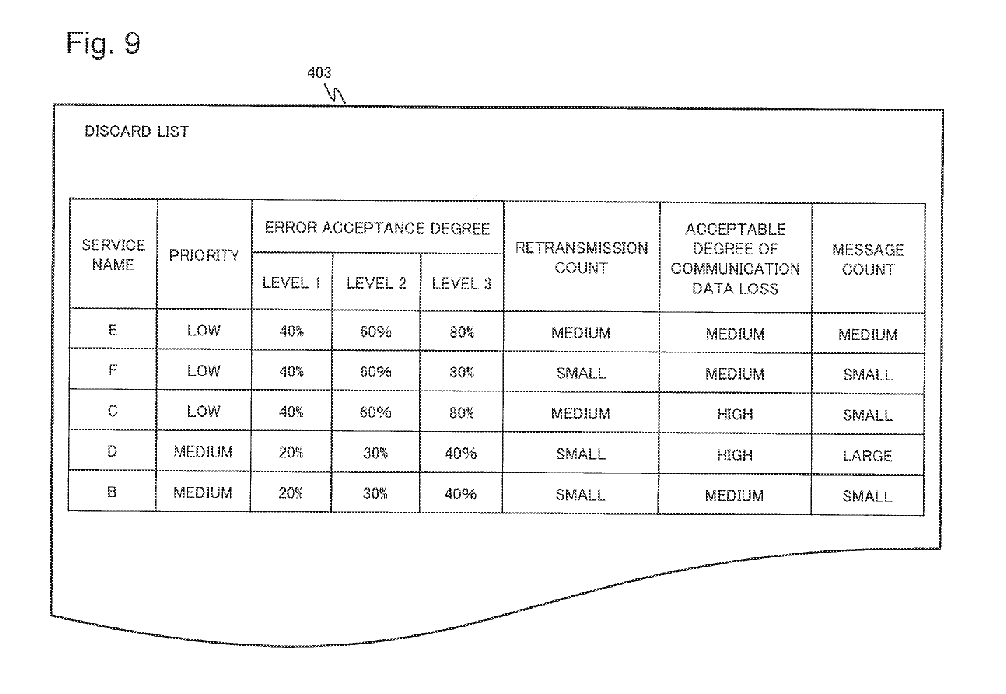

In this case, certain service may not be registered in a discard list 403 according to a priority of each service. More specifically, for example, the discard rule generating unit 402 may not register, in the discard list 403, a service (“service A”) of which priority is set “high” in the specific example exemplified in FIG. 6. The exemplary embodiment is not limited to the above. For example, a service that is not registered in the discard list 403 may be a service of which priority is equal to or larger than a specific priority. By deciding a service that is not registered in the discard list 403, the discard rule generating unit 402 is able to generate the discard rule 306 configured such that, for example, communication data of a mission-critical service is not discarded. FIG. 9 is a diagram illustrating a specific example of the discard list 403 generated as a result of Step S801.

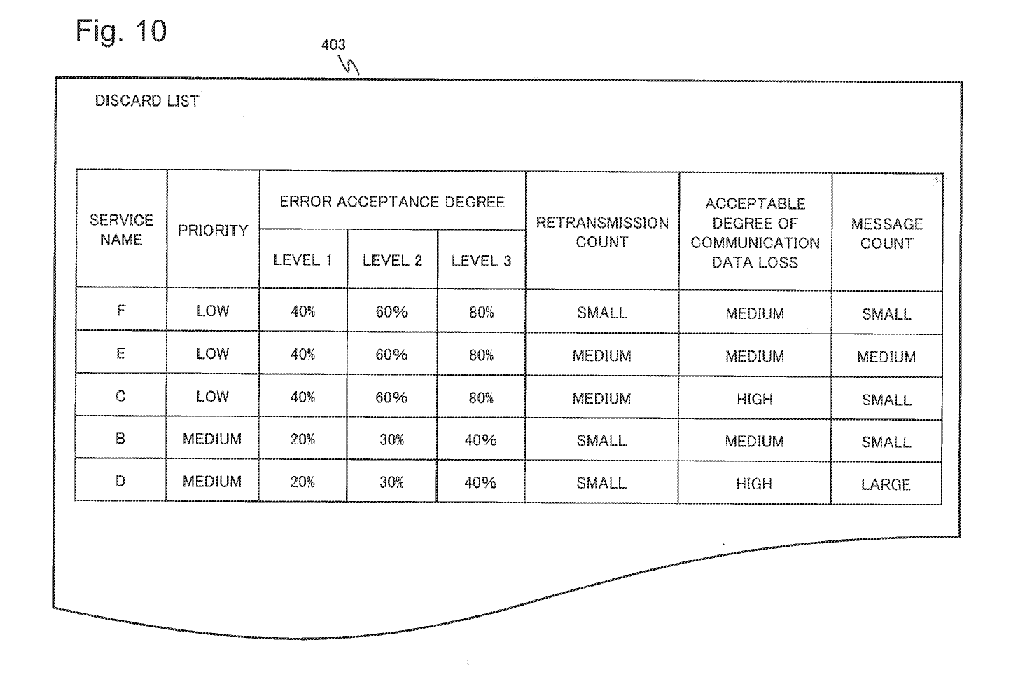

Next, the discard rule generating unit 402 rearranges the services with same priority in the ascending order of the count of retransmission, on the basis of the system knowledge 304 (Step S802), in the discard list 403 generated in Step S801. FIG. 10 is a diagram illustrating a specific example of a rearranged discard list 403 as a result of Step S802.

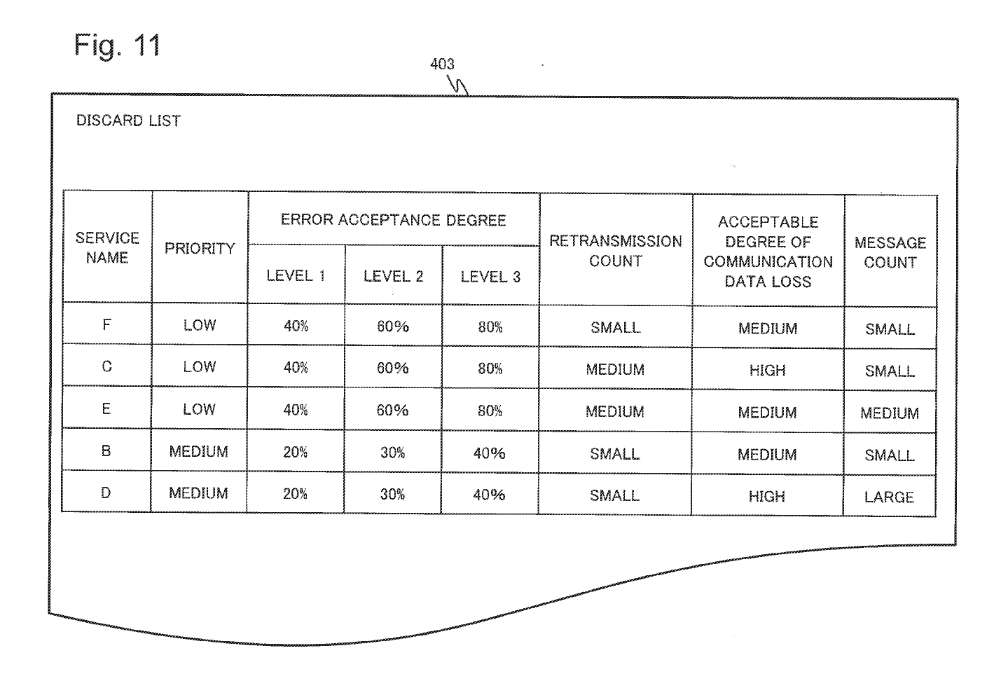

Next, the discard rule generating unit 402 rearranges the services of which count of retransmission are the same in the ascending order of the length of a message sequence, on the basis of the system knowledge 304, in the discard list 403 rearranged in Step S802 (Step S803). In the exemplary embodiment, the ascending order of the length of a message sequence may be the ascending order of the value set in the message count 504. FIG. 11 is a diagram illustrating a specific example of the rearranged discard list 403 as a result of Step S803.

The discard rule generating unit 402 generates the discard rule 306 including “information usable for specifying a service of which communication data is discarded (for example “service name”)”, and “communication data discard rate”, by referring to the generated discard list 403.

More specifically, at first, the discard rule generating unit 402 generates the discard rule 306 including information for specifying a service listed at a head of the discard list 403 (in the actual example exemplified in FIG. 11, “service F”), and a communication data discard rate relating to the service.

The communication data discard rate is information for use in discarding communication data relating to a service included in the discard rule 306 with a probability equal to or lower than the communication data discard rate in the inter-site network gateway 301 to be described later.

In the generated discard list 403, a service of which priority is low and of which count of retransmission is small is listed at a head of the list. When communication data relating to a service listed at a head of the discard list 403 is discarded, an error occurs for entire message sequence relating to the service, and the entire message sequence may be lost. In this case, communication data may decrease by the amount equal to or larger than a communication data discard rate designated in a discard rule. In view of the above, the communication data discard rate to be set in the discard rule 306 may be equal to or lower than the communication data loss rate examined in Step S702. This is because communication data may be discarded by the amount equal to or larger than a communication data loss rate, when the communication data loss rate is set as the communication data discard rate.

The discard rule generating unit 402 may store a level of error acceptance degree set with respect to a service to be described in the discard rule 306. In the specific example exemplified in FIG. 11, the discard rule generating unit 402 may store the “level 1” as the error acceptance degree with regard to “service F”.

Further, the discard rule generating unit 402 may include, in the discard rule 306, an error acceptance degree (level of error acceptance degree) with respect to a service to be described in the discard rule 306.

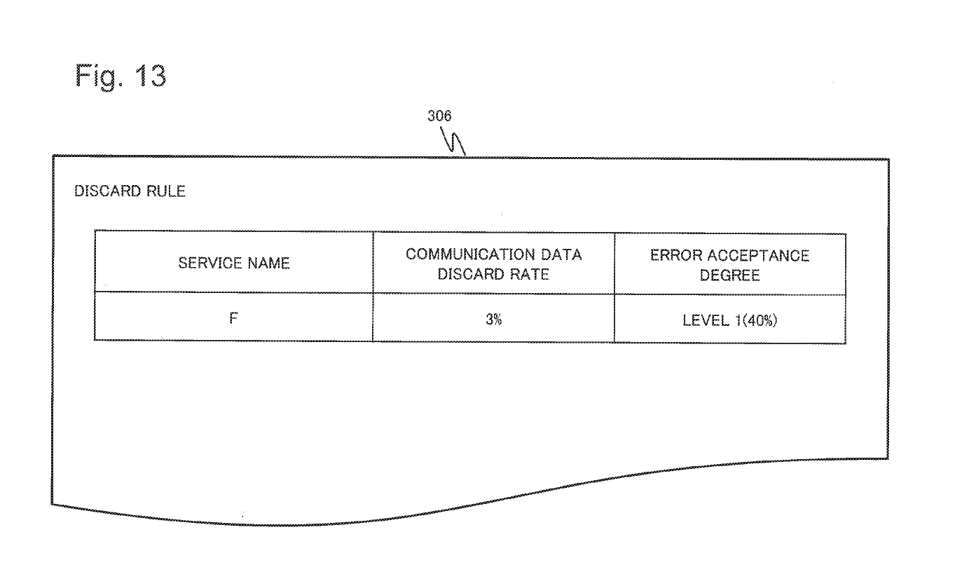

FIG. 13 is a diagram illustrating a specific example of the discard rule 306 generated in Step S704. The specific example exemplified in FIG. 13 is a discard rule describing that communication data relating to “service F” at a head of the discard list exemplified in FIG. 11 is discarded by “3%”, for example.

Next, the discard rule generating unit 402 applies the generated discard rule 306 to the inter-site network gateway 301 (Step S705). In the following, a process of Step S705 is described.

Firstly, the discard rule generating unit 402 notifies the generated discard rule 306 to the inter-site network gateway 301. Note that the method for implementing notification may use a technology currently available in general. Therefore, detailed description about the method in the exemplary embodiment is omitted herein.

In response to the notification, the inter-site network gateway 301 analyzes the notified discard rule 306. Then, the inter-site network gateway 301 discards communication data relating to a service included in the discard rule 306 (in this case, “service F” exemplified in FIG. 13) with a probability equal to or lower than a communication data discard rate included in the discard rule 306. In this case, the inter-site network gateway 301 may control so that communication data to be discarded is not transmitted to the inter-site network 103.

Note that a specific method for discarding communication data in the inter-site network gateway 301 may employ a technology currently available in general. Therefore, detailed description about the method in the exemplary embodiment is omitted herein.

Next, the communication quality examination unit 401 in the inter-site network control apparatus 302 continuously collects a communication data loss rate in the inter-site network 103 as well as in Step S701. Then, the communication quality examination unit 401 examines whether the collected communication data loss rate becomes larger than the reference value (Step S706).

In this case, for example, the communication quality examination unit 401 may periodically collect a communication data loss rate after start of discarding process of communication data in the inter-site network gateway 301, or may collect a communication data loss rate after a predetermined period of time elapses from the start of discarding process.

By the process of Step S706, the communication quality examination unit 401 detects whether the communication data loss rate decreases by discarding communication data according to the generated discard rule 306.

When the communication data loss rate is equal to or lower than the reference value as a result of examination in Step S706 (NO in Step S707), the inter-site network control apparatus 302 continues the process from Step S701. Specifically, in this case, communication data loss decreases by a communication data discarding process on the basis of the generated discard rule 306.

On the other hand, when the communication data loss rate exceeds the reference value as a result of examination in Step S706 (YES in Step S707), the inter-site network control apparatus 302 changes the discard rule (Step S708).

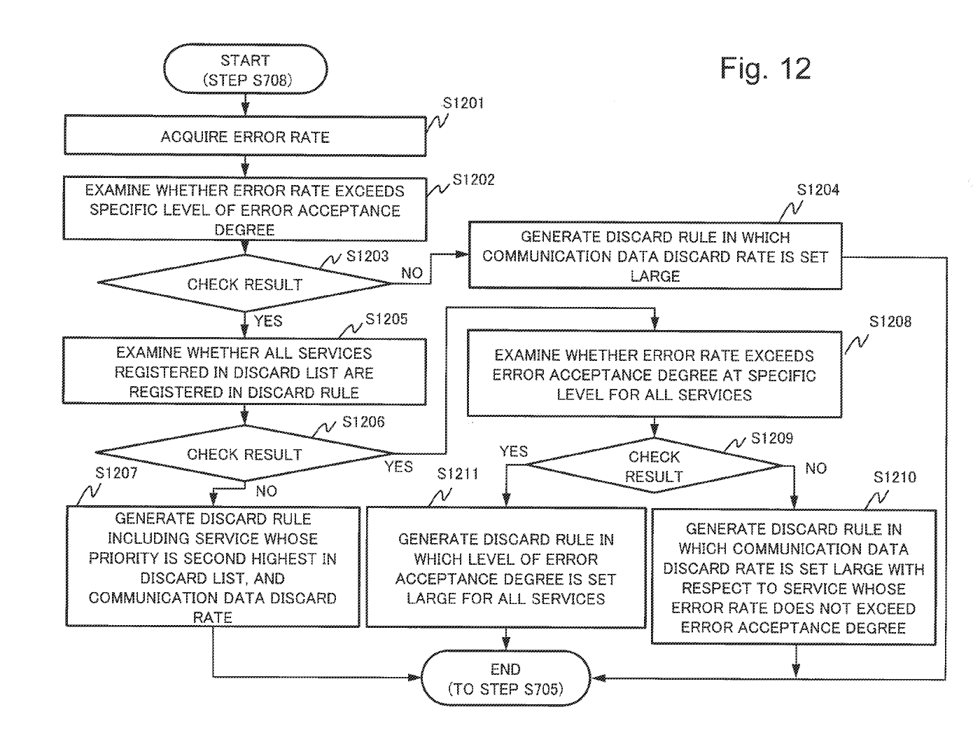

In the following, the process of Step S708 is described referring to the flowchart exemplified in FIG. 12.

Firstly, the discard rule generating unit 402 obtains an occurrence rate of error, which is caused by discarding of communication data relating to a specific service (for example “service F”) described in the discard rule 306 (Step S1201). Hereinafter, the occurrence rate of error is also referred to as an “error rate”.

The error rate may employ, for example, a communication data discard rate with respect to a specific service. Alternatively, a system for providing a specific service may measure an occurrence rate of error caused by discarding of communication data relating to the specific service by any method. Then, the discard rule generating unit 402 may obtain the measurement result as an error rate from the system for providing the specific service. The specific method for measuring an error rate may employ a technology currently available in general. Therefore, detailed description about the method in the exemplary embodiment is omitted herein.

Next, the discard rule generating unit 402 examines whether an error rate obtained in Step S1201 exceeds a specific level of error acceptance degree with respect to the service (Step S1202).

In the specific example of the discard rule 306 illustrated in FIG. 13, the error acceptance degree is set to “level 1” with respect to “service F”.

The discard rule generating unit 402 examines whether the error rate examined as above exceeds the error acceptance rate corresponding to a specific level of error acceptance degree (in this case, the error acceptance rate “40%” corresponding to “level 1” regarding “service “F”), by referring to the operational policy 305.

When an error rate relating to the specific service does not exceed the error acceptance rate relating to the specific service as the result of examination in Step S1202 (NO in Step S1203), the discard rule generating unit 402 executes the following process. That is, the discard rule generating unit 402 generates a discard rule 306 in which more larger communication data discard rate is set, on the basis of the generated discard rule 306 (Step S1204).

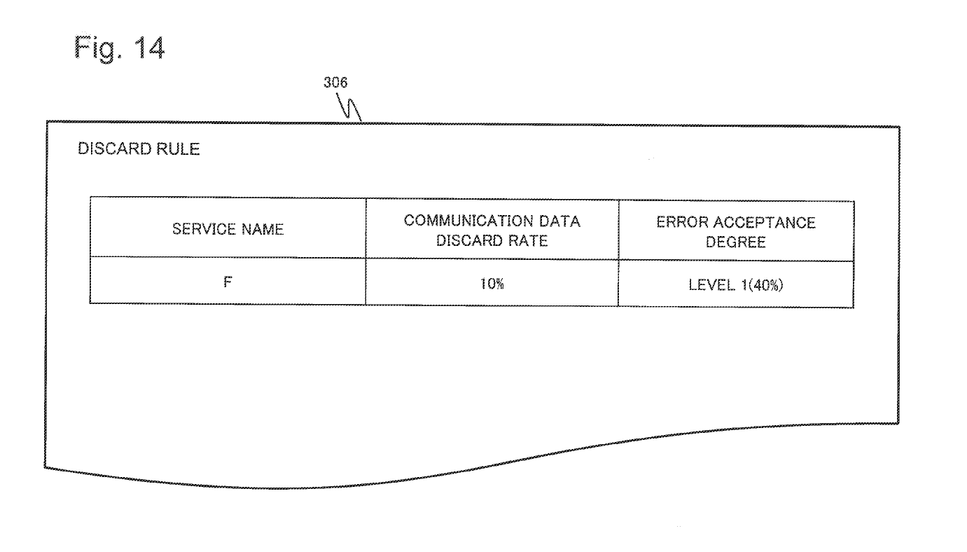

Specifically, for example, when the discard rule 306 as exemplified in FIG. 13 is applied to the inter-site network gateway 301, the discard rule generating unit 402 generates a discard rule 306 in which the communication data discard rate (“3%”) with respect to “service “F” is increased. FIG. 14 illustrates a specific example of the discard rule 306 to be generated in this case. In the specific example illustrated in FIG. 14, a communication data discard rate with respect to “service F” is set to “10%”.

Next, when the error rate relating to the specific service exceeds the error acceptance rate relating to the specific service (YES in Step S1203), the discard rule generating unit 402 executes the following process. Firstly, the discard rule generating unit 402 examines whether all the services registered in the discard list 403 are registered in the discard rule 306 (Step S1205). In other words, the discard rule generating unit 402 examines whether there is a service that is not registered in the discard rule 306 among the services registered in the discard list 403.

When there is a service that is not registered in the discard rule 306 (NO in Step S1206), the discard rule generating unit 402 selects a service of which priority is second rank with respect to the priority of a service registered in the discard rule 306 among the services registered in the discard list 403. Then, the discard rule generating unit 402 generates a discard rule including the selected service, and a communication data discard rate with respect to the selected service (Step S1207).

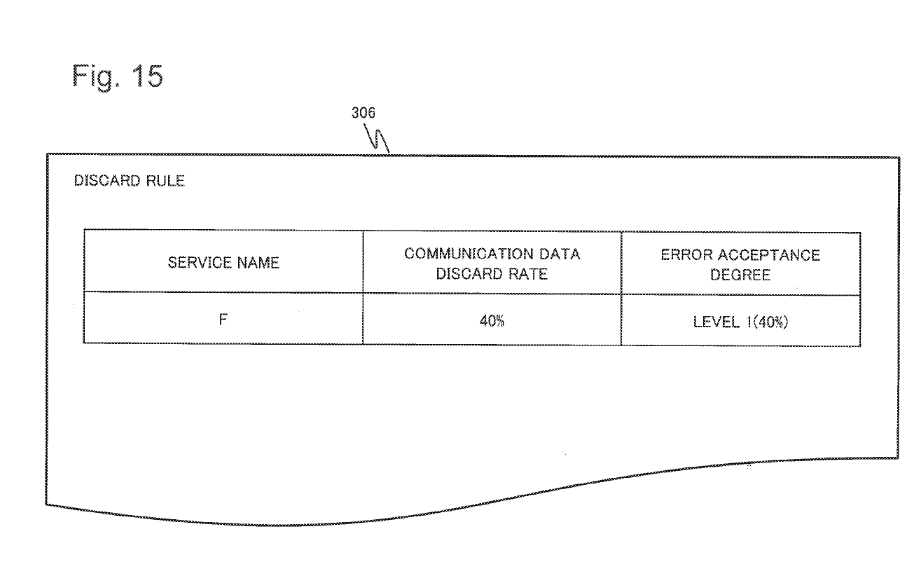

In the following, the aforementioned process is described using a specific example. As illustrated in a specific example exemplified in FIG. 15, it is assumed that “service F”, and a communication data discard rate “40%” with respect to “service F” are registered in the discard rule 306. In this case, when the error rate with respect to “service F” exceeds the error acceptance degree (in this case, “40%” at “level 1”) (YES in Step S1203), the discard rule generating unit 402 examines whether there is a service that is not registered in the discard rule 306 among the services registered in the discard list 403 (Step S1205).

In the specific example exemplified in FIG. 11, “service C, “service E”, “service B”, and “service D” are registered in the discard list 403, as services other than “service F”. However, these services are not registered in the discard rule 306 (NO in Step S1206).

Therefore, the discard rule generating unit 402 selects a service of which priority is second rank with respect to the priority of a service registered in the discard rule 306 (in the specific example exemplified in FIG. 15, “service F”) among the services registered in a discard list. Referring to the specific example exemplified in FIG. 11, in this case “service C” corresponds to the condition.

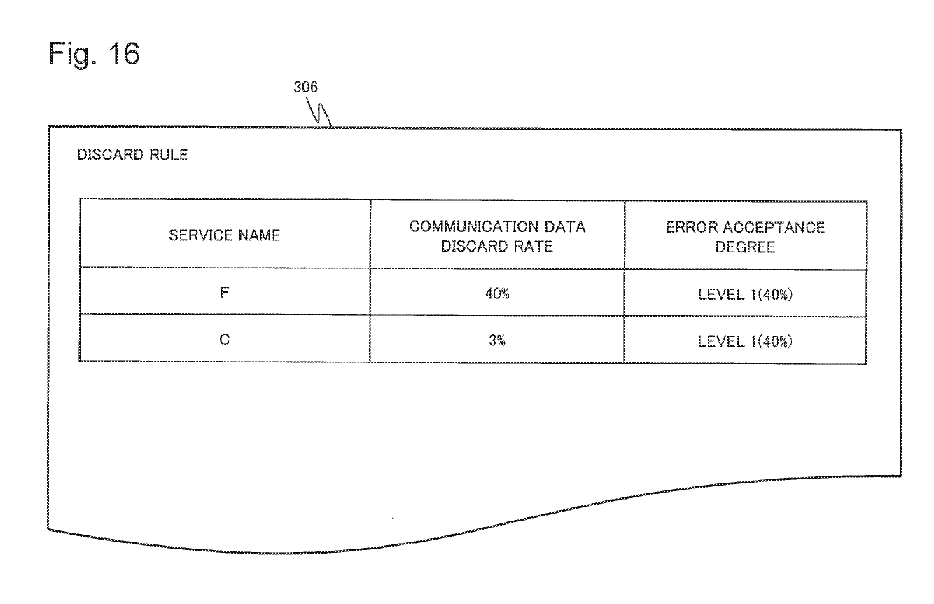

The discard rule generating unit 402 generates a discard rule, in which the selected “service C”, and a communication data discard rate with respect to “service C” are set (Step S1207). FIG. 16 is a diagram illustrating a specific example of the discard rule 306 generated as described above.

Next, when all the services registered in the discard list 403 are registered in the discard rule 306 as a result of examination in Step S1205 (YES in Step S1206), the discard rule generating unit 402 executes the following process. That is, the discard rule generating unit 402 examines whether an error rate relating to a service exceeds an error acceptance rate at a specific level for all the services registered in the discard rule 306 (Step S1208).

When there is the service of which error rate does not exceed the error acceptance rate at a specific level (NO in Step S1209), the discard rule generating unit 402 generates the discard rule 306, in which the communication data discard rate with respect to the service is increased (Step S1210).

In the following, a case that an error rate exceeds the error acceptance rate at a specific level for all the services registered in the discard rule 306, as a result of examination in Step S1208 (YES in Step S1209) is described.

In this case, the discard rule generating unit 402 generates a discard rule, in which the level of error acceptance degree in the operational policy 305 is raised for each service registered in a discard rule (Step S1211).

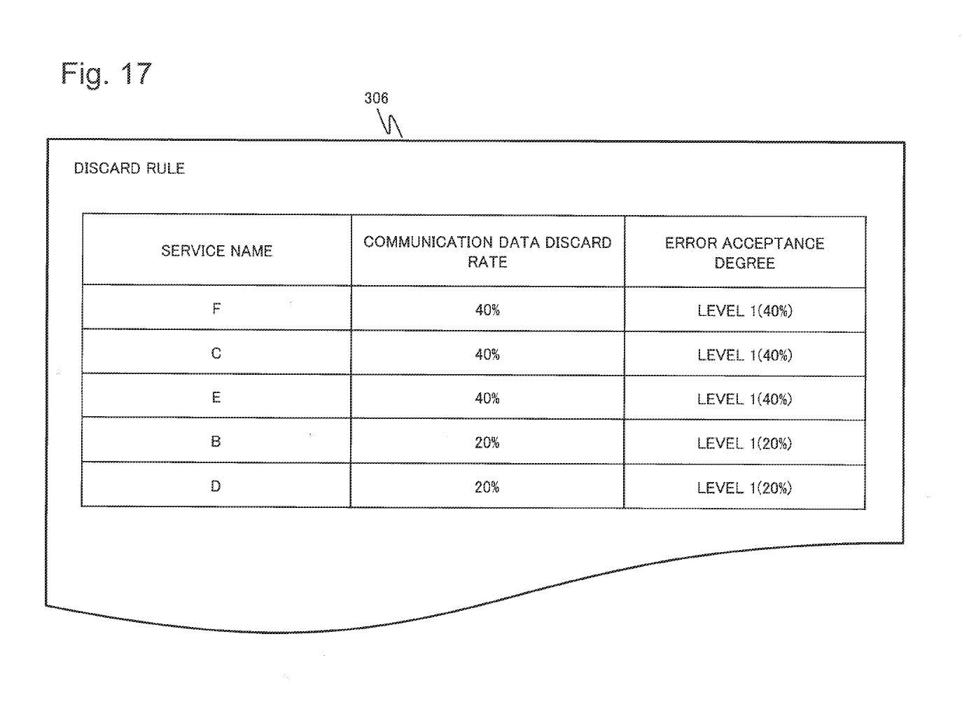

In the following, a specific case is described referring to a specific example. For example, it is assumed that the discard rule 306 has the content as exemplified in FIG. 17. Further, it is assumed that an error rate with respect to all the registered services (“service F” to “service D”) exceeds the error acceptance rate at “level 1” with respect to each of the services (YES in Step S1209).

In this case, the discard rule generating unit 402 sets the error acceptance degree with respect to “service F” to “service D” to “level 2”, and generates a discard rule 306, in which the communication data discard rate of “service F” is increased.

That is, the discard rule generating unit 402 changes the level of error acceptance degree with respect to each service. According to this configuration, the discard rule generating unit 402 generates the discard rule 306 usable for discarding communication data with respect to each of the services by the inter-site network gateway 301 until the error rate reaches the error acceptance rate after the change.

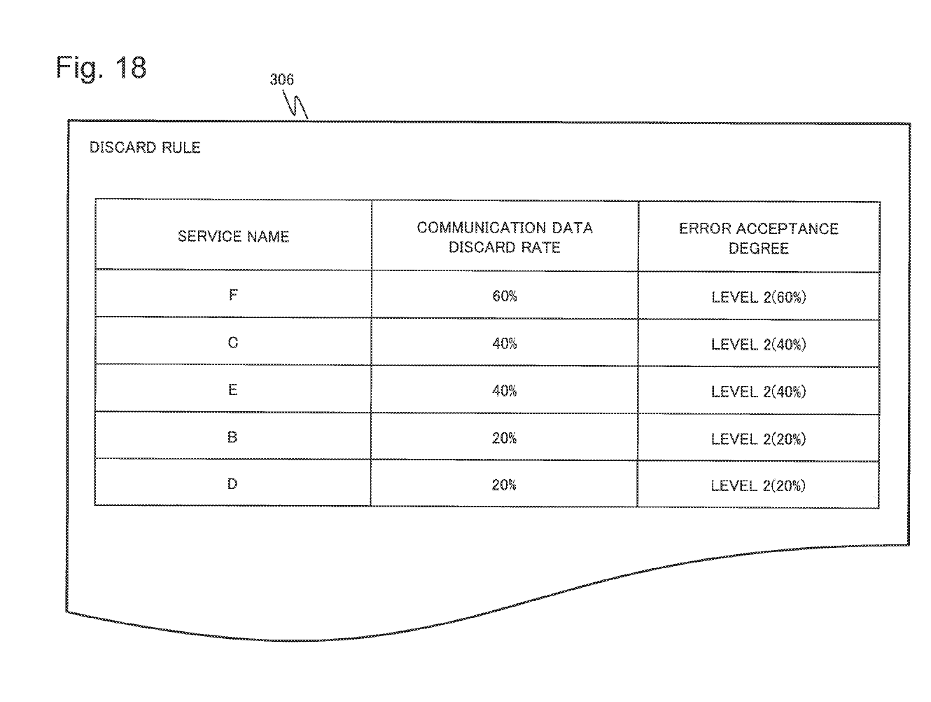

FIG. 18 is a diagram exemplifying a specific example of the discard rule 306 generated as described above. Comparing FIG. 17 and FIG. 18, in FIG. 18, the error acceptance degree with respect to each service is set to “level 2”, and the communication data discard rate with respect to “service F” is changed from “40%” to “60%”. The communication data discard rate may be set (or selected) as necessary.

After the process exemplified in FIG. 12 is terminated, the inter-site network control apparatus 302 continues the process from Step S705.

As described above, the inter-site network control apparatus 302 in the exemplary embodiment generates the discard rule 306 of communication data on the basis of the communication quality deterioration information 303, the system knowledge 304, and the operational policy 305. Then, the inter-site network gateway 301 discards communication data relating to a specific service on the basis of the discard rule 306.

In this example, the discard rule 306 reflects priority information relating to each service registered in the operational policy 305, and information relating to a retransmission process of each service registered in the system knowledge 304. Therefore, the inter-site network gateway 301 is capable of prioritizing discarding of communication data relating to a service of which priority is low, or a service of which consumption of resources by a retransmission process is small.

As described above, according to the network system 100 in the exemplary embodiment, it is possible to selectively discard communication data in the network 103 for connecting sites. According to this configuration, the network system 100 in the exemplary embodiment is capable of reducing consumption of a communication band by communication data, and is capable of reducing a processing load for use in processing communication data. Thus, the network system 100 in the exemplary embodiment is capable of performing a stable operation, and preventing deterioration of the quality of services.

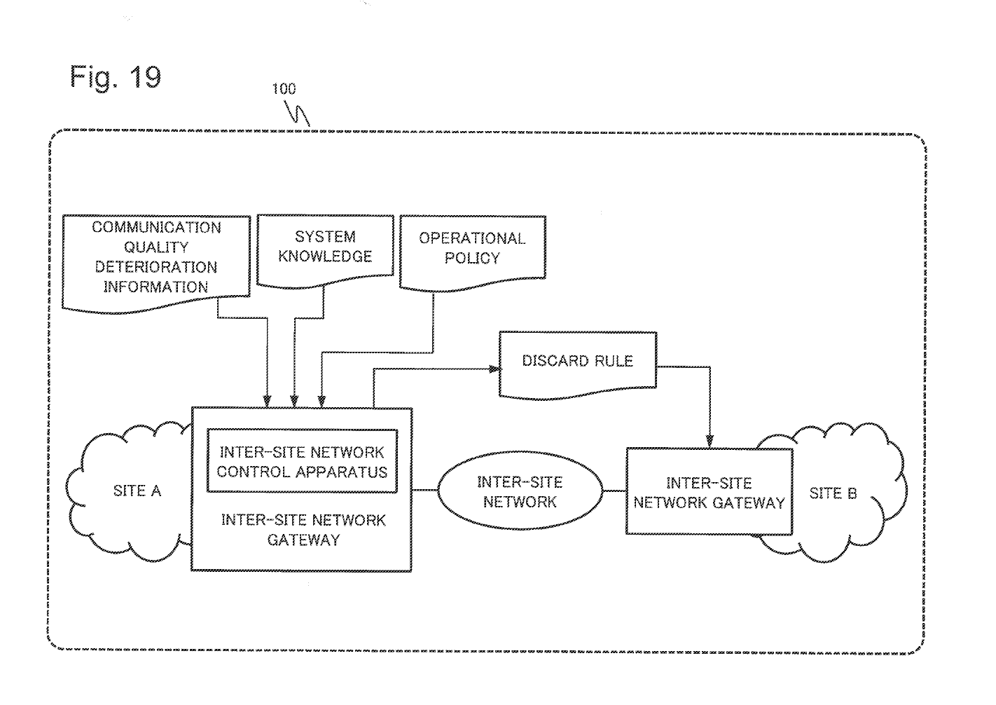

Note that in the configuration example exemplified in FIG. 3 to FIG. 4, the inter-site network control apparatus 302 is provided independently of the inter-site network gateways 301. The exemplary embodiment is not limited to the above. For example, as exemplified in FIG. 19, the inter-site network control apparatus 302 and the inter-site network gateway 301 may be integrally configured.

Further, in the exemplary embodiment, the discard rule changing process in Step S708 is not limited to the process exemplified in FIG. 12.

For example, the discard rule generating unit 402 may raise the level of error acceptance degree with respect to a specific service (for example “service F” exemplified in FIG. 15) when the error acceptance degree exceeds a specific level with respect to the service (Step S1202 in FIG. 12). Specifically, in the specific example exemplified in FIG. 15, the discard rule generating unit 402 may generate a discard rule 306, in which the level of error acceptance degree with respect to “service F” is set to “2”, instead of executing Steps S1205 to S1207 in FIG. 12. In this case, the discard rule generating unit 402 may register, in the discard rule 306, a service of which priority is second rank (in this case, “service C”) with regard to the priority of the “service F”, when the level of acceptance degree with respect to “service F” becomes highest (in this case, “level 3”).

Further, a process for generating a discard rule in the exemplary embodiment (Step S704 exemplified in FIG. 7) is not limited to the processing method as described above. In the configuration as described above, the discard rule generating unit 402 generates a discard rule relating to a service listed at a head of a discard list generated in Step S803. The exemplary embodiment is not limited to the above. For example, the discard rule generating unit 402 may select a service to be registered in a discard rule on the basis of a predetermined criterion from the discard list generated as above. The discard rule generating unit 402 may adopt a criterion, such as selecting services from a head of the discard list, up to n-th position from the head (where n is any natural number), as the predetermined criterion.

Note that, a well-known technology may be selected appropriately, for a method for expressing specific data relating to the system knowledge 304, the operational policy 305, the discard rule 306, the discard list 403, and the like in the first exemplary embodiment. For example, the expression may use a language adaptable for expressing a structure such as XML (Extensible Markup Language). Alternatively, any other data format may be used.

### Second Exemplary Embodiment

Next, a second exemplary embodiment of the present invention is described. In the following description, a characteristic portion according to the exemplary embodiment is mainly described, and redundant description about the same configuration as in the first exemplary embodiment is omitted herein.

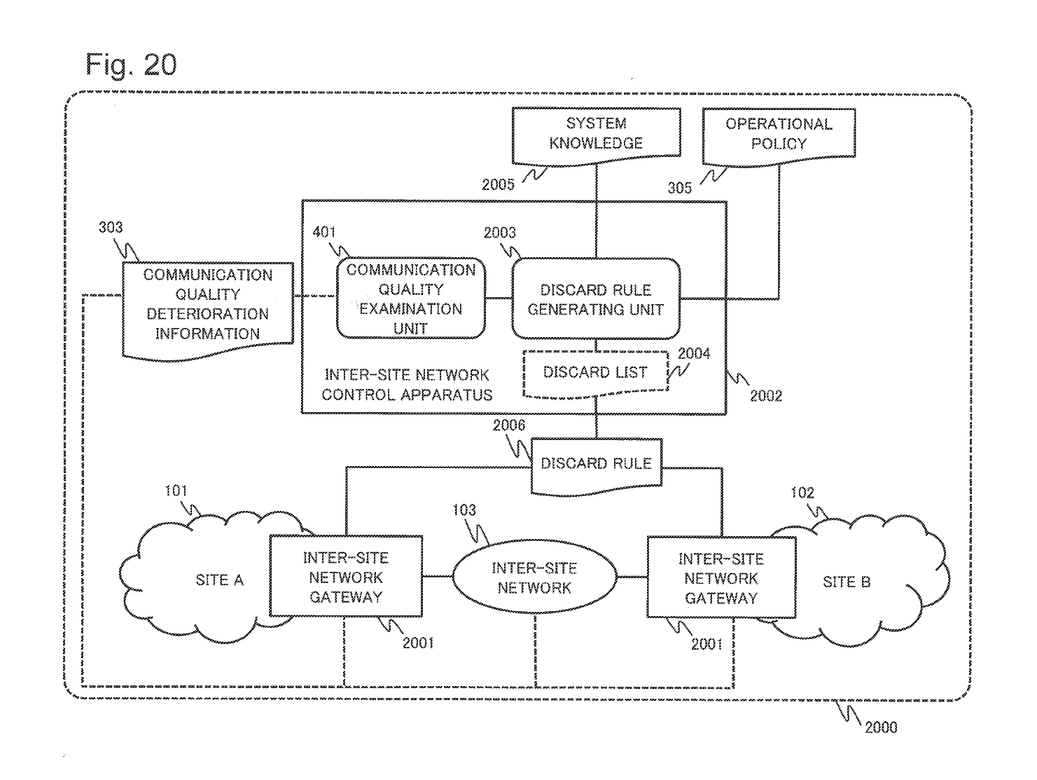

An inter-site network control apparatus 2002 and inter-site network gateways 2001 in the exemplary embodiment exemplified in FIG. 20 discard communication data relating to a service, taking the content of a message sequence constituting each service into consideration. The inter-site network control apparatus 2002 and the inter-site network gateway 2001 are different from those in the first exemplary embodiment in this point. The second exemplary embodiment is substantially the same as the first exemplary embodiment in the other points. In the following, the differences are described, and detailed description about the other configuration is omitted herein.

FIG. 20 is a diagram exemplifying components of a network system 2000 according to the exemplary embodiment.

The inter-site network control apparatus 2002 in the exemplary embodiment generates a discard rule 2006 such that communication data at a position close as possible to a head of a message sequence is selected and discarded, on the basis of information relating to a message sequence constituting each service.

In the following, a relationship between each service and a message sequence is described.

For example, in a communication service such as an EPC or an IMS, unlike a simple client-server system, one message sequence is accomplished by transmitting and receiving communication data between a plurality of servers.

When an error being caused by communication data loss occurs in middle of the message sequence, a portion of the message sequence being executed before the error, becomes useless. Further, when it is necessary to execute a process (such as a cleanup process) to recovery from a state in which an error has occurred, various data is further transmitted and received between the servers. In this case, for example, a communication band of the inter-site network 103, or resources of each server or the like related to the message sequence may be wasted.

If communication data, at a position close to a head of the message sequence, can be discarded, it is possible to efficiently reduct communication data flowing through the inter-site network 103 without wasting resources.

In the exemplary embodiment, on the basis of a command being included in a message configuring each message sequence constituting a specific service, a position, in the message sequence, of communication data relating to the specific service is determined. Specifically, a message to be discarded is selected on the basis of command information transmitted from a client at the beginning of a message sequence, such as “Attach” command in the case of an EPC, and an “INVITE” command in the case of an IMS. Then, communication data used for transmitting and receiving the selected message, is discarded.

In the following, generation of the discard rule 2006 is described.

Firstly, system knowledge 2005 in the exemplary embodiment includes, for each service provided in the network system 2000, command information to be included in a message being transmitted and received in the vicinity of a head of a message sequence constituting the service. In the following, the command is also referred to as a “discardable command”. When a plurality of message sequences constituting the service exist for each service, the system knowledge 2005 may include information relating to a plurality of discardable commands as a list, for example.

Next, a discard rule generating unit 2003 in the exemplary embodiment generates a discard list 2004 on the basis of the system knowledge 2005 and an operational policy 305. A basic process for generating the discard list 2004 may be the same as in the first exemplary embodiment (the flowchart exemplified in FIG. 8). Therefore, detailed description about the process is omitted herein.

In this example, the discard rule generating unit 2003 in the exemplary embodiment registers, in the discard list 2004, discardable command information registered in the system knowledge 2005.

Next, the discard rule generating unit 2003 generates a discard rule 2006 on the basis of the generated discard list 2004. Note that a basic process for generating the discard rule 2006 may be the same as in the first exemplary embodiment. Therefore, detailed description about the process is omitted herein.

In this example, the discard rule generating unit 2003 in the exemplary embodiment adds the discardable command information for each service registered in the discard rule 2006. Specifically, the discard rule 2006 in the exemplary embodiment includes information of discardable command which is included in a message being transmitted and received in the vicinity of a head of a message sequence constituting each service, in addition to the discard rule described in the first exemplary embodiment.

The discard rule generating unit 2003 in the exemplary embodiment notifies the generated discard rule 2006 to the inter-site network gateway 2001.

In response to the notification, the inter-site network gateway 2001 analyzes the notified discard rule 2006. Then, the inter-site network gateway 2001 discards communication data relating to a service included in the discard rule 2006, with a probability equal to or lower than a communication data discard rate included in the discard rule 2006.

In this case, by referring to discardable command information to be included in the discard rule 2006, the inter-site network gateway 2001 discards, for each service, communication data including a discardable command relating to the service, with priority. When a communication data discard rate registered in a discard rule cannot be achieved only by discarding of communication data including the discard-handling command, the inter-site network gateway 2001 may discard communication data other than the discard-handling command.

The other components constituting the network system 2000 in the exemplary embodiment may be the same as those in the first exemplary embodiment except for the differences as described above.

As described above, the inter-site network control apparatus 2002 in the exemplary embodiment configured as described above generates the discard rule 2006 for communication data on the basis of communication quality deterioration information 303, the system knowledge 2005, and the operational policy 305. Then, the inter-site network gateway 2001 discards communication data relating to a specific service on the basis of the discard rule 2006.

In this exemplary embodiment, the discard rule 2006 reflects priority information relating to each service registered in the operational policy, and information relating to a retransmission process of each service registered in the system knowledge. Further, in the exemplary embodiment, the discard rule 2006 reflects information relating to a discardable command as described above.

According to this configuration, the inter-site network gateway 2001 in the exemplary embodiment is capable of prioritizing discarding of communication data relating to a service of which priority is low, or a service of which consumption of resources by a retransmission process is small. Further, the inter-site network gateway 2001 is capable of selectively discarding communication data relating to a message to be transmitted and received in the vicinity of a head of a message sequence constituting a specific service.

As described above, according to the network system 2000 in the exemplary embodiment, it is possible to provide the same advantageous effects as described in the first exemplary embodiment, and to more efficiently discard communication data. Therefore, the network system 2000 in the exemplary embodiment can be stably operated, and can prevent deterioration of the quality of services.

### Third Exemplary Embodiment

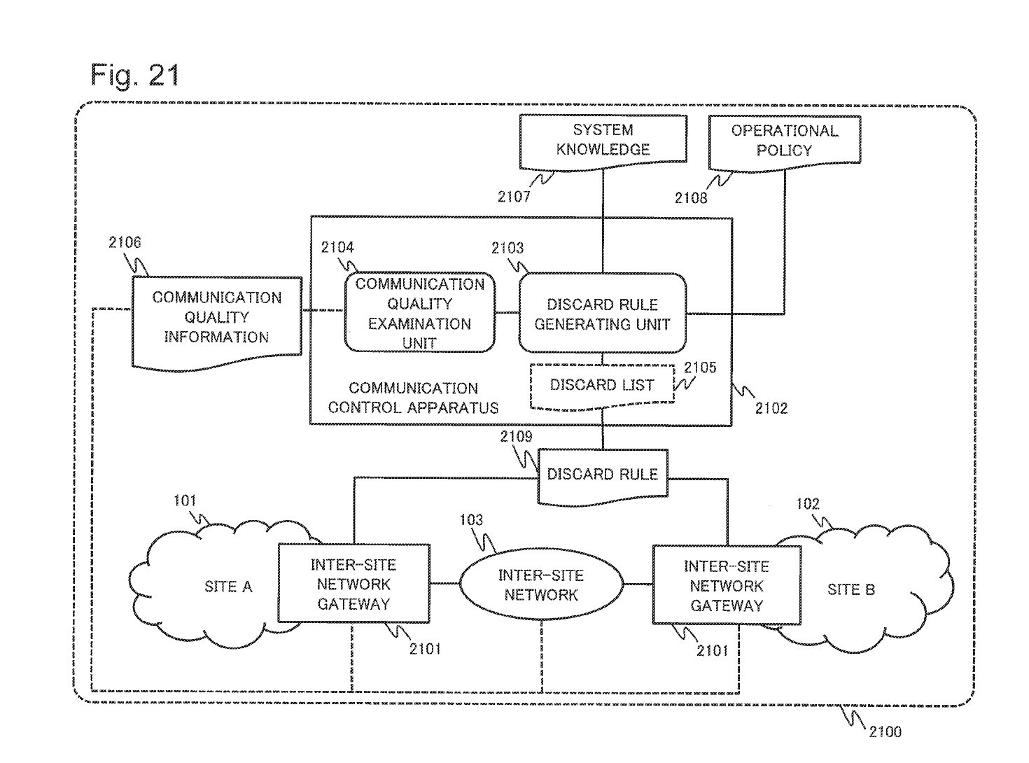

Next, a configuration common among the exemplary embodiments is described as a third exemplary embodiment of the present invention referring to FIG. 21.

A communication control apparatus 2102 in the exemplary embodiment includes a communication quality examination unit 2014 and a discard rule generating unit 2103.

The communication quality examination unit 2104 in the exemplary embodiment examines communication quality information 2106 representing communication quality in a network system 2100. The communication quality information 2106 may describe, for example, a communication data loss rate in an inter-site network 103. The communication quality information 2106 corresponds to the communication quality deterioration information 303 in each of the exemplary embodiments.

The discard rule generating unit 2103 in the exemplary embodiment generates a discard rule 2109 for use in discarding communication data in the network system 2100 on the basis of the communication quality information 2106 examined by the communication quality examination unit 2104, system knowledge 2107, and an operational policy 2108.

In this example, the system knowledge 2107 in the exemplary embodiment includes information relating to retransmission control with respect to communication data for implementing a service to be provided in the network system 2100.

The operational policy 2108 in the exemplary embodiment includes information representing a priority of a service to be provided in the network system 2100.

The communication control apparatus 2102 in the exemplary embodiment may apply the discard rule 2109 to an inter-site network gateway 2101. In this case, the inter-site network gateway 2101 discards communication data relating to each service to be transmitted and received in the inter-site network 103 on the basis of the discard rule 2109.

According to the communication control apparatus 2102 in the exemplary embodiment, it is possible to generate a discard rule capable of selectively discarding communication data relating to a specific service in the inter-site network 103. Therefore, according to the exemplary embodiment, it is possible to reduce consumption of a communication band due to communication data relating to a specific service by discarding the communication data on the basis of the discard rule, and to reduce a processing load for use in processing communication data. Thus, according to the exemplary embodiment, the network system 2100 can be stably operated, and can prevent lowering of the quality of services.

<Configuration of Hardware Component and Software Program (Computer Program)>

In the following, a hardware component and a software program which are capable of implementing each of the components of the network system in each of the exemplary embodiments as described above is described. In the following description, elements constituting the network system described in each of the exemplary embodiments is also generically referred to as “components of a network system”. Specifically, the inter-site network control apparatus (302, 2002, the communication control apparatus 2102) and the inter-site network gateway (301, 2001, 2101) are also generically referred to as “components of a network system”. The inter-site network control apparatus (302, 2002, the communication control apparatus 2102) is hereinafter also generically referred to as an “inter-site network control apparatus”. Further, the inter-site network gateway (301, 2001, 2101) is also generically referred to as an “inter-site network gateway”.

The components of the network system described in each of the exemplary embodiments may be configured by a dedicated hardware apparatus for implementing each of the functions. In this case, the components of the network system may be implemented as a hardware component (such as an integrated circuit implemented with a processing logic) in which all the functions are integrated, or may be configured by combination of individual hardware components for implementing a specific function.

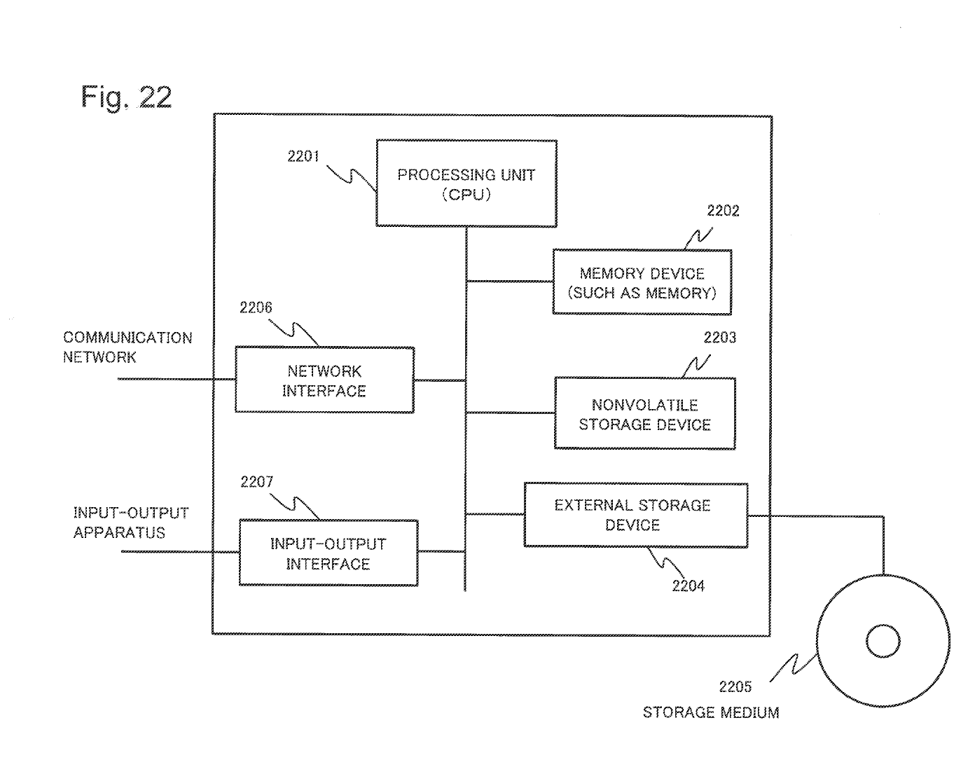

The components of the network system may also be configured by the hardware component as exemplified in FIG. 22, and various software programs (computer programs) to be executed by the hardware component. Note that in the following description, the hardware component exemplified in FIG. 22 is also simply referred to as an information processing hardware component.

In this case, the components of the network system may be implemented as a software program to be executed by a single information processing hardware component. Further, the components of the network system may also be implemented as a software program to be executed by a plurality of information processing hardware components.

The components of the network system may be configured by a virtual information processing apparatus provided in a virtual environment implemented by an information processing hardware component or the like, and a software program executed by the virtual information processing apparatus.

A processing unit 2201 in FIG. 22 is a processing unit such as a general-purpose central processing unit (CPU) or a microprocessor. The processing unit 2201 may read various software programs stored, for example, in a nonvolatile storage device 2203 to be described later from a memory device 2202, and may execute a process according to the software program.

The memory device 2202 is a memory device such as a random access memory (RAM) referable from the processing unit 2201. The memory device 2202 stores a software program, various data, and the like. Note that the memory device 2202 may be a volatile memory device.

The nonvolatile storage device 2203 is a nonvolatile storage device such as a magnetic disk drive or a semiconductor storage device such as a flash memory. The nonvolatile storage device 2203 may record various software programs, data, and the like.

A network interface 2206 is an interface apparatus to be connected to a network. The network interface 2206 may adopt, for example, a wired and wireless interface apparatus for LAN connection. In each of the exemplary embodiments as described above, the components of the network system may be connected to the inter-site network 103 or to the intra-site network 106 via the network interface 2206.

An external storage device 2204 is, for example, a device for processing reading and writing of data with respect to a storage medium 2205 to be described later.

The storage medium 2205 is an arbitrary recording medium capable of recording data, such as an optical disc, a magneto-optical disk, or a semiconductor flash memory.

An input-output interface 2207 is a device for controlling input and output with respect to an external input apparatus (for example a keyboard or a mouse), and with respect to an external output apparatus (for example a display apparatus or a printer).

In each of the exemplary embodiments as described above, for example, an unillustrated service provider or the like may input the system knowledge (304, 2005, 2107), the operational policy (305, 2108), and the like to an inter-site network control apparatus with use of the input-output interface 2207.

The present invention described by way of the example of each of the exemplary embodiments may be achieved as described below. Specifically, for example, each of the information processing apparatuses is configured by the information processing hardware component exemplified in FIG. 22. A software program capable of implementing the function represented by flowchart referred in description of the each exemplary embodiments is supplied to the information processing hardware component. Thereafter, the processing unit 2201 executes the software program.

In this case, in each of the exemplary embodiments, each of the units illustrated in each of the drawings (for example the communication quality examination unit (401, 2104), and the discard rule generating unit (402, 203, 2103)) may be implemented as a software module. The software module is a functional (processing) unit of a software program to be executed by the hardware component. Arrangement of each of software modules illustrated in these drawings is an exemplary configuration for convenience of description. Various configurations may be adaptable in actual implementation.

For example, when each unit constituting the information processing apparatus or the like is implemented as a software module, these software modules may be stored in the nonvolatile storage device 2203. Then, the processing unit 2201 may read these software modules from the memory device 2202 in executing each of the processes.

Further, these software modules may be configured to transmit various data to each other by an appropriate method such as a shared memory or inter-processes communication. According to this configuration, these software modules are communicatively connectable to each other.

Each of the software programs may be recorded in the storage medium 2205. Then, at the time of shipment of the communication apparatus or the like, at the time of operation, or the like, a software program recorded in the storage medium 2205 may be stored in the nonvolatile memory 2203 through the external storage device 2204, as necessary.

When the components of the network system in each of the exemplary embodiments are implemented as a software program, the following configuration described in each of the exemplary embodiments may be stored in the memory device 2202 or in the nonvolatile storage device 2203. Specifically, the system knowledge (304, 2005, 2107), the operational policy (305, 2108), and the like may be stored in each of the memory devices with use of an appropriate data structure or the like. These items of information may be stored in the nonvolatile storage device 2203 by storing the items of information in any database or the like.

Note that a method for supplying various software programs to each of the information processing apparatuses or the like may employ the following procedure currently available in general. Specifically, the supply method may be a method for installing software programs in the apparatus with use of an appropriate tool in a manufacturing stage before shipment, in a maintenance stage after shipment, or the like. Further, the supply method may be a method for downloading software programs from the outside via a communication line such as the Internet. In the aforementioned case, it is possible to consider that the present invention is configured by a code constituting the software programs, or by a computer-readable storage medium in which the code is recorded.

As described above, the present invention is described as an example in which the present invention is applied to the aforementioned exemplary embodiments. The technical scope of the present invention, however, is not limited to the range described in each of the exemplary embodiments. It is obvious that a person skilled in the art can add various modifications or improvements to the exemplary embodiments. In this case, a new exemplary embodiment in which the modifications or improvements are added may be included in the technical scope of the present invention. This is obvious from the matters described in the claims.

Note that a part or all of the exemplary embodiments and the modifications thereof may also be described as the following Supplemental Notes. However, the present invention as exemplarily described by the exemplary embodiments and the modifications thereof is not limited to the following.

(Supplemental Note 1)

A communication control apparatus including:
a communication quality examination means for examining communication quality information representing communication quality in a communication network system; and
a discard rule generating means for generating a discard rule used for discarding communication data in the communication network system on the basis of the communication quality information examined by the communication quality examination means, system knowledge information including information relating to retransmission control with respect to communication data used for implementing a service to be provided in the communication network system, and operational policy information including a priority with respect to one or more of the services to be provided in the communication network system.

(Supplemental Note 2)

The communication control apparatus according to Supplemental Note 1, wherein
the information relating to retransmission control includes at least one of information relating to retransmission count of communication data and information relating to a retransmission interval of communication data, the communication data configuring a message sequence constituting the service.

(Supplemental Note 3)

The communication control apparatus according to Supplemental Note 1 or 2, wherein
the discard rule generating means
   generates a discard list in which information relating to the services is arranged in an ascending order of the priority, on the basis of the operational policy information, and
   generates a discard rule including information relating to a service arranged at a head of the discard list, and information relating to a communication data discard rate indicating a discard rate of communication data relating to the service, when the communication quality examination means determines that communication quality has deteriorated, on the basis of a reference value that can be utilized for determining deterioration of communication quality.

(Supplemental Note 4)

The communication control apparatus according to Supplemental Note 3, wherein
the discard rule generating means
   rearranges the discard list on the basis of the information relating to retransmission control, and
   generates a discard rule including information relating to a service arranged at the head of the discard list, and information relating to a communication data discard rate being a discard rate of communication data relating to the service when the communication quality examination means determines that communication quality has deteriorated, on the basis of a reference value that can be utilized for determining deterioration of communication quality.

(Supplemental Note 5)

The communication control apparatus according to any one of Supplemental Notes 1 to 4, wherein
the communication network system includes a plurality of sites communicatively connected to each other by a communication network, the plurality of sites being capable of providing the service,
each of the plurality of sites includes an inter-site communication control means capable of controlling transmitting and receiving of communication data relating to the service, and
the discard rule generating means applies the generated discard rule to the inter-site communication control means.

(Supplemental Note 6)

The communication control apparatus according to Supplemental Note 5, wherein
the communication quality examination means examines the communication quality information after the discard rule generating means applies the discard rule to the inter-site communication control means, and
the discard rule generating means
   generates the discard rule including a discard rate representing that an amount of communication data to be discarded becomes larger than the communication data discard rate, when the communication quality information examined by the communication quality examination means is larger than the reference value, and
   applies the generated discard rule to the inter-site communication control means.

(Supplemental Note 7)

The communication control apparatus according to Supplemental Notes 5 or 6, wherein
the operational policy information includes an error acceptance degree including a plurality of levels,
at each of the levels, an acceptable range capable of accepting an error that is caused by discarding of communication data relating to a service is set for each of the services included in the operational policy information,
when a specific level, among the plurality of levels, is set for each of the services included in the operational policy information,
the communication quality examination means examines, with regard to a first service included in the discard rule, the error caused by discarding of communication data relating to the first service, and
the discard rule generating means
   generates a discard rule including information relating to a second service which is included in the discard list and of which priority is set equal to or lower than the priority of the first service, and information relating to the communication data discard rate with regard to the second service, when the error examined by the communication quality examination means exceeds the acceptable range represented by the specific level set to the first service, and
   applies the generated discard rule to the inter-site communication control means.

(Supplemental Note 8)

The communication control apparatus according to any one of Supplemental Notes 5 to 7, wherein
a message sequence constituting the service includes at least one or more messages,
the message includes command information capable of specifying a position of the message in the message sequence,
the system knowledge information further includes, for each of the services, discardable command information representing the command information that is included in a message to be discarded in the message sequence constituting the service, and
the discard rule generating means generates the discard rule including the discardable command information, and applies the generated discard rule to the inter-site communication control means.

(Supplemental Note 9)

A communication control method including:
examining communication quality information representing communication quality in a communication network system; and
generating a discard rule used for discarding communication data in the communication network system on the basis of the examined communication quality information, system knowledge information including information relating to retransmission control with respect to communication data used for implementing a service to be provided in the communication network system, and operational policy information including a priority with respect to one or more of the services to be provided in the communication network system.

(Supplemental Note 10)

A storage medium recorded with a communication control program which causes a computer to execute:
a process for examining communication quality information representing communication quality in a communication network system; and
a process for generating a discard rule used for discarding communication data in the communication network system on the basis of the examined communication quality information, system knowledge information including information relating to retransmission control with respect to communication data used for implementing a service to be provided in the communication network system, and operational policy information including a priority with respect to one or more of the services to be provided in the communication network system.

(Supplemental Note 11)

The communication control apparatus according to Supplemental Note 1, wherein
the discard rule generating means generates the discard rule, when the communication quality information exceeds a first reference value, examined by the communication quality examination means.

(Supplemental Note 12)

The communication control apparatus according to Supplemental Note 2, wherein
the system knowledge information further includes information representing length of the message sequence constituting the service.

(Supplemental Note 13)

The communication control apparatus according to Supplemental Note 12, wherein
at least one or more messages are included in the message sequence constituting the service,
the information representing length of the message sequence represents the number of messages.

(Supplemental Note 14)

The communication control apparatus according to Supplemental Note 1, wherein
the communication quality information represents a loss rate of communication data.

(Supplemental Note 15)

The communication control apparatus according to Supplemental Note 4, wherein
when the information relating to retransmission control includes retransmission count that represents the number of retransmission of communication data used for the message sequence constituting the service,
the discard rule generating means
   rearranges the discard list in the ascending order of the retransmission count, and
   generates the discard rule including information of the service registered in the discard list and the communication data discard rate of the service from the service arranged at the head of the discard list, when the communication quality information exceeds the reference value.

(Supplemental Note 16)

The communication control apparatus according to Supplemental Note 12, wherein
the discard rule generating means
   rearranges the discard list in the ascending order of length of the message sequence, and
   generates the discard rule including information of the service registered in the discard list and the communication data discard rate of the service from the service arranged at the head of the discard list, when the communication quality information exceeds the reference value.

(Supplemental Note 17)

The communication control apparatus according to Supplemental Note 14,
the communication data discard rate included in the discard rule generated by the discard rule generating means is less than or equal to the loss rate of communication data.

(Supplemental Note 18)

The communication control apparatus according to Supplemental Note 7, wherein
when, with regard to at least one or more of the specific services, the error caused by discarding of communication data relating to the specific service exceeds an upper limit of the specific level set to the specific service, the discard rule generating means sets, to the specific service, another level having larger acceptable range than the specific level.

(Supplemental Note 19)

The communication control apparatus according to Supplemental Note 1 or 2, wherein
the discard rule generation means
   generates the discard list in which information relating to the services is arranged in an ascending order of the priority, on the basis of the operational policy information, and
   generates a discard rule including information relating to the service arranged within specific range from a head of the discard list, and information relating to a communication data discard rate indicating a discard rate of communication data relating to the service, when the communication quality examination means determines that communication quality has deteriorated, on the basis of a reference value that can be utilized for determining deterioration of communication quality.

(Supplemental Note 20)

The communication control apparatus according to Supplemental Note 3, wherein
the discard rule generation means
   rearranges the discard list on the basis of the information relating to retransmission control, and
   generates a discard rule including information relating to the service arranged within specific range from a head of the discard list, and information relating to a communication data discard rate being a discard rate of communication data relating to the service, when the communication quality examination means determines that communication quality has deteriorated, on the basis of a reference value that can be utilized for determining deterioration of communication quality.

### INDUSTRIAL APPLICABILITY

The present invention is applicable to a network system configured such that deterioration of the quality of services due to communication data loss by band shortage in a network is prevented. More specifically, the present invention is applicable to a network service or the like, which provides communication services across a plurality of sites.

The present invention is described as above by way of the aforementioned exemplary embodiments as exemplary examples. The present invention, however, is not limited by the aforementioned exemplary embodiments. Specifically, the present invention can incorporate various configurations comprehensible to a person skilled in the art in the scope of the present invention.

This application is based upon and claims the benefit of priority from Japanese patent application No. 2014-040255, filed on Mar. 3, 2014, the disclosure of which is incorporated herein in its entirety by reference.

### REFERENCE SIGNS LIST

100 Network system
101 Site A
102 Site B
103 Inter-site network
104 VM
105 VM
106 Intra-site network
201 Interface
202 Client
301 Inter-site network gateway
302 Inter-site network control apparatus
303 Communication quality deterioration information
304 System knowledge
305 Operational policy
306 Discard rule
401 Communication quality examination unit
402 Discard rule generating unit
403 Discard list
2001 Inter-site network gateway
2002 Inter-site network control apparatus
2003 Discard rule generating unit
2004 Discard list
2005 System knowledge
2006 Discard rule
2101 Inter-site network gateway
2102 Communication control apparatus
2103 Discard rule generating unit
2104 Communication quality examination unit
2106 Communication quality information
2107 System knowledge
2108 Operational policy
2109 Discard rule
2201 Processing unit
2202 Memory device
2203 Nonvolatile storage device
2204 External storage device
2205 Storage medium
2206 Network interface
2207 Input-output interface

1. A communication control apparatus comprising:
a communication quality examination unit that is configured to examine communication quality information representing communication quality in a communication network system; and
a discard rule generating unit that is configured to generate a discard rule used for discarding communication data in the communication network system on the basis of the communication quality information examined by the communication quality examination unit, system knowledge information including information relating to retransmission control with respect to communication data used for implementing a service to be provided in the communication network system, and operational policy information including a priority with respect to one or more of the services to be provided in the communication network system.

2. The communication control apparatus according to claim 1, wherein
the information relating to retransmission control includes at least one of information relating to a retransmission count of communication data and information relating to a retransmission interval of communication data, the communication data configuring a message sequence constituting the service.

3. The communication control apparatus according to claim 2, wherein
the discard rule generating unit
generates a discard list in which information relating to the services is arranged in an ascending order of the priority, on the basis of the operational policy information, and
generates a discard rule including information relating to the service arranged at a head of the discard list, and information relating to a communication data discard rate indicating a discard rate of communication data relating to the service, when the communication quality examination unit determines that communication quality has deteriorated, on the basis of a reference value that can be utilized for determining deterioration of communication quality.

4. The communication control apparatus according to claim 3, wherein
the discard rule generating unit
rearranges the discard list on the basis of the information relating to retransmission control, and
generates a discard rule including information relating to the service arranged at the head of the discard list, and information relating to a communication data discard rate being a discard rate of communication data relating to the service when the communication quality examination unit determines that communication quality has deteriorated, on the basis of a reference value that can be utilized for determining deterioration of communication quality.

5. The communication control apparatus according to claim 4, wherein
the communication network system includes a plurality of sites communicatively connected to each other by a communication network, the plurality of sites being capable of providing the service,
each of the plurality of sites includes an inter-site communication control unit configured to control transmitting and receiving of communication data relating to the service, and
the discard rule generating unit applies the generated discard rule to the inter-site communication control unit.

6. The communication control apparatus according to claim 5, wherein
the communication quality examination unit examines the communication quality information after the discard rule generating unit applies the discard rule to the inter-site communication control unit, and
the discard rule generating unit
generates the discard rule including a discard rate representing that an amount of communication data to be discarded becomes larger than the communication data discard rate, when the communication quality information examined by the communication quality examination unit is larger than the reference value, and
applies the generated discard rule to the inter-site communication control unit.

7. The communication control apparatus according to claim 5, wherein
the operational policy information includes an error acceptance degree including a plurality of levels,
at each of the levels, an acceptable range capable of accepting an error that is caused by discarding of communication data relating to the service is set for each of the services included in the operational policy information,
when a specific level, among the plurality of levels, is set for each of the services included in the operational policy information,
the communication quality examination unit examines, with regard to a first service included in the discard rule, the error caused by discarding of communication data relating to the first service, and
the discard rule generating unit
generates a discard rule including information relating to a second service which is registered in the discard list and of which priority is set equal to or lower than the priority of the first service, and information relating to the communication data discard rate with regard to the second service, when the error examined by the communication quality examination unit exceeds the acceptable range represented by the specific level set to the first service, and
applies the generated discard rule to the inter-site communication control unit.

8. The communication control apparatus according to claim 5, wherein
a message sequence constituting the service includes at least one or more messages,
the message includes command information capable of specifying a position of the message in the message sequence,
the system knowledge information further includes, for each of the services, discardable command information representing the command information that is included in a message to be discarded in the message sequence constituting the service, and
the discard rule generating unit generates the discard rule including the discardable command information, and applies the generated discard rule to the inter-site communication control unit.

9. A communication control method comprising:
examining communication quality information representing communication quality in a communication network system; and
generating a discard rule used for discarding communication data in the communication network system on the basis of the examined communication quality information, system knowledge information including information relating to retransmission control with respect to communication data used for implementing a service to be provided in the communication network system, and operational policy information including a priority with respect to one or more of the services to be provided in the communication network system.

10. A non-transitory computer-readable storage medium recorded with a communication control program which causes a computer to execute:
a process for examining communication quality information representing communication quality in a communication network system; and
a process for generating a discard rule used for discarding communication data in the communication network system on the basis of the examined communication quality information, system knowledge information including information relating to retransmission control with respect to communication data used for implementing a service to be provided in the communication network system, and operational policy information including a priority with respect to one or more of the services to be provided in the communication network system.
